(19) United States
(12) Patent Application Publication
(10) Pub. No.: US 2026/0290363 A1
(43) Pub. Date: Sep. 24, 2026

(54) AUDIO CODING METHOD AND APPARATUS, AND ELECTRONIC DEVICE AND STORAGE MEDIUM

(71) Applicant: Beijing Xiaomi Mobile Software Co., Ltd., Beijing (CN)

(72) Inventors: Guangshuo ZHANG, Beijing (CN); Bin WANG, Beijing (CN); Yong LIU, Beijing (CN)

(21) Appl. No.: 19/474,843

(22) PCT Filed: Apr. 12, 2024
(86) PCT No.: PCT/CN2024/087626

§ 371 Date: Oct. 13, 2025

(30) Foreign Application Priority Data
Apr. 14, 2023 (CN) 202310403661.8

(51) Int. Cl. G10L 19/022; G10L 19/008; H04S 7/00

(52) U.S. Cl. CPC G10L 19/022; G10L 19/008; H04S 7/30

(57) ABSTRACT

An audio encoding method includes: obtaining a plurality of channel groups by performing a grouping on a channel sequence; obtaining a frequency domain coefficient of each frame in each channel by performing a frequency domain conversion on an audio signal in each channel in the channel sequence frame by frame; determining a target transformation matrix corresponding to a channel group in each frequency band in a frequency band set from a transformation matrix set according to the frequency domain coefficient of each channel; obtaining encoded information of the channel group by performing an identical-band decorrelation processing on the frequency domain coefficient of the channel in the channel group based on the target transformation matrix in each frequency band; and obtaining an encoded stream based on the encoded information of the channel group, and sending the encoded stream to a decoder for decoding.

### CROSS-REFERENCE TO RELATED APPLICATION

The present disclosure a US national phase entry of International Application PCT/CN2024/087626 filed on Apr. 12, 2024, which claims priority to Chinese patent application No. 202310403661.8 filed on Apr. 14, 2023, the entire contents of both of which are incorporated herein by reference.

### TECHNICAL FIELD

The present disclosure relates to the field of audio processing technologies, and in particular relates to an audio encoding method, an audio decoding method, an audio encoding apparatus, an audio decoding apparatus, an electronic device, a non-transitory computer-readable storage medium, a computer program product, and a computer program.

### BACKGROUND

With the development of multimedia technologies, the requirements for audio signals are becoming increasingly higher. Although existing two-dimensional mid-side audio algorithms (2D MS) may effectively reduce data redundancy between multiple channels, the existing algorithms increase transmission costs and cause data waste in the data transmission process in a variety of different audio scenarios.

### SUMMARY

In a first aspect, embodiments of the present disclosure provide an audio encoding method, which is performed by an encoder and includes: obtaining a plurality of channel groups by performing a grouping on a channel sequence, where each of the plurality of channel groups includes a plurality of consecutive channels in the channel sequence, and adjacent channel groups include one or more identical channels; obtaining a frequency domain coefficient of each frame in each channel by performing a frequency domain conversion on an audio signal in each channel in the channel sequence frame by frame; determining a target transformation matrix corresponding to the channel group in each frequency band in a frequency band set from a transformation matrix set according to the frequency domain coefficient of each channel; obtaining encoded information of the channel group by performing an identical-band decorrelation processing on the frequency domain coefficient of the channel in the channel group based on the target transformation matrix in each frequency band; and obtaining an encoded stream based on the encoded information of the channel group, and sending the encoded stream to a decoder for decoding.

In a second aspect, embodiments of the present disclosure provide an audio decoding method, which is performed by a decoder and includes: receiving an encoded stream sent by an encoder, where the encoded stream includes encoded information of a plurality of channel groups, the plurality of channel groups are obtained by performing a grouping on a channel sequence sequentially, each of the plurality of the channel groups includes a plurality of consecutive channels in the channel sequence, and adjacent channel groups include one or more identical channels; decoding the plurality of channel groups sequentially, and determining, for a current channel group decoded, a target decoding matrix corresponding to the current channel group in each frequency band in a frequency band set according to encoded information of the current channel group; obtaining a decoded frequency domain coefficient of the current channel group for the encoded information of the current channel group based on the target decoding matrix for the current channel group in each frequency band; and obtaining a decoded audio signal in each channel in the channel sequence according to the decoded frequency domain coefficients of the plurality of channel groups.

In a third aspect, embodiments of the present disclosure provide an audio encoding apparatus, which includes: a channel grouping module configured to obtain a plurality of channel groups by performing a grouping on a channel sequence, where each of the plurality of the channel groups includes a plurality of consecutive channels in the channel sequence, and adjacent channel groups include one or more identical channels; a frequency domain processing module configured to obtain a frequency domain coefficient of each frame in each channel by performing a frequency domain conversion on an audio signal in each channel in the channel sequence frame by frame; a matrix determining module configured to determine a target transformation matrix corresponding to the channel group in each frequency band in a frequency band set from a transformation matrix set according to the frequency domain coefficient of each channel; an encoding module configured to obtain encoded information of the channel group by performing an identical-band decorrelation processing on the frequency domain coefficient of the channel in the channel group based on the target transformation matrix in each frequency band; and a sending module configured to obtain an encoded stream based on the encoded information of the channel group, and send the encoded stream to a decoder for decoding.

In a fourth aspect, embodiments of the present disclosure provide an audio decoding apparatus, which includes: a receiving module configured to receive an encoded stream sent by an encoder, where the encoded stream includes encoded information of a plurality of channel groups, the plurality of channel groups are obtained by performing a grouping on a channel sequence sequentially, each of the plurality of the channel groups includes a plurality of consecutive channels in the channel sequence, and adjacent channel groups include one or more identical channels; a matrix determining module configured to decode the plurality of channel groups sequentially, and determine, for a current channel group decoded, a target decoding matrix corresponding to the current channel group in each frequency band in a frequency band set according to encoded information of the current channel group; and a decoding module configured to obtain a decoded frequency domain coefficient of the current channel group for the encoded information of the current channel group based on the target decoding matrix for the current channel group in each frequency band, and obtain a decoded audio signal in each channel in the channel sequence according to the decoded frequency domain coefficients of the plurality of channel groups.

In a fifth aspect, embodiments of the present disclosure provide an encoder, which includes a processor and a memory for storing instructions executable by the processor. The processor is configured to perform the method described in the first aspect.

In a sixth aspect, embodiments of the present disclosure provide a decoder, which includes a processor and a memory for storing instructions executable by the processor. The processor is configured to perform the method described in the second aspect.

In a seventh aspect, embodiments of the present disclosure provide a non-transitory computer-readable storage medium having stored therein computer program instructions that, when executed by a processor, cause the processor to perform the method described in the first aspect.

In an eighth aspect, embodiments of the present disclosure provide a non-transitory computer-readable storage medium having stored therein computer program instructions that, when executed by a processor, cause the processor to perform the method described in the second aspect.

In a ninth aspect, embodiments of the present disclosure provide an encoder, which includes a processor and an interface circuit configured to receive code instructions and transmit the code instructions to the processor. The processor is configured to run the code instructions to cause the encoder to perform the method described above in the first aspect.

In a tenth aspect, embodiments of the present disclosure provide a decoder, which includes a processor and an interface circuit configured to receive code instructions and transmit the code instructions to the processor. The processor is configured to run the code instructions to cause the decoder to perform the method described above in the second aspect.

In an eleventh aspect, embodiments of the present disclosure provide an encoding and decoding system, which includes the audio encoding apparatus described in the third aspect and the audio decoding apparatus described in the fourth aspect, or includes the encoder described in the fifth aspect and the decoder described in the sixth aspect, or includes the non-transitory computer-readable storage medium described in the seventh aspect and the non-transitory computer-readable storage medium described in the eighth aspect, or includes the encoder described in the ninth aspect and the decoder described in the tenth aspect.

In a twelfth aspect, embodiments of the present disclosure provide a non-transitory computer-readable storage medium for storing instructions used by the above-mentioned encoder that, when executed, cause the encoder to perform the method described above in the first aspect.

In a thirteenth aspect, embodiments of the present disclosure provide a non-transitory computer-readable storage medium for storing instructions used by the above-mentioned decoder that, when executed, cause the decoder to perform the method described above in the second aspect.

In a fourteenth aspect, embodiments of the present disclosure further provide a computer program product including a computer program that, when run on a computer, causes the computer to perform the method described above in the first aspect.

In a fifteenth aspect, embodiments of the present disclosure further provide a computer program product including a computer program that, when run on a computer, causes the computer to perform the method described above in the second aspect.

In a sixteenth aspect, embodiments of the present disclosure provide a chip system, including at least one processor and an interface for supporting a network device to implement the functions involved in the first aspect, for example, determining or processing at least one of data or information involved in the above-mentioned method. In a possible design, the chip system further includes a memory, which is configured to store desired computer programs and data for the network device. The chip system may be composed of chips, or may include chips and other discrete devices.

In a seventeenth aspect, embodiments of the present disclosure provide a chip system, including at least one processor and an interface for supporting a terminal to implement the functions involved in the second aspect, for example, determining or processing at least one of data or information involved in the above-mentioned method. In a possible design, the chip system further includes a memory, which is configured to store desired computer programs and data for the terminal. The chip system may be composed of chips, or may include chips and other discrete devices.

In an eighteenth aspect, embodiments of the present disclosure provide a computer program that, when run on a computer, causes the computer to perform the method described above in the first aspect.

In a nineteenth aspect, embodiments of the present disclosure provide a computer program that, when run on a computer, causes the computer to perform the method described above in the second aspect.

It is to be understood that both the foregoing general description and the following detailed description are illustrative and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart illustrating an audio encoding method performed by an encoder according to an illustrative embodiment.

FIG. 2 is a flow chart illustrating an audio encoding method according to another illustrative embodiment.

FIG. 3 is a schematic diagram of a cross-correlation matrix according to an illustrative embodiment.

FIG. 4 is a flow chart illustrating an audio encoding method according to another illustrative embodiment.

FIG. 5 is a flow chart illustrating an audio encoding method according to another illustrative embodiment.

FIG. 6 is a schematic diagram illustrating an audio encoding method according to an illustrative embodiment.

FIG. 7 is a flow chart illustrating an audio decoding method performed by a decoder according to an illustrative embodiment.

FIG. 8 is a flow chart illustrating an audio decoding method according to another illustrative embodiment.

FIG. 9 is a schematic diagram illustrating an audio decoding method according to an illustrative embodiment.

FIG. 10 is a flow chart illustrating an audio coding method according to another illustrative embodiment.

FIG. 11 is a block diagram illustrating an audio encoding apparatus according to an illustrative embodiment.

FIG. 12 is a block diagram illustrating an audio decoding apparatus according to an illustrative embodiment.

FIG. 13 is a block diagram illustrating an audio processing apparatus according to an illustrative embodiment.

FIG. 14 is a block diagram of another audio processing chip according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure. Instead, they are merely examples of apparatuses and methods consistent with some aspects of the disclosure as recited in the appended claims.

Terms used herein in the embodiments of the present disclosure are only for the purpose of describing specific embodiments, but should not be construed to limit the embodiments of the present disclosure. As used in the embodiments of the present disclosure and the appended claims, “a/an” and “the” in singular forms are intended to include plural forms, unless clearly indicated in the context otherwise. It should also be understood that the term “and/or” used herein represents and contains any or all possible combinations of one or more associated listed items.

It should be noted that the terms “first”, “second”, and the like in the specification and claims of the present disclosure and the above-mentioned drawings are used to distinguish similar objects, and are not necessarily used to describe a specific order or sequence. It is to be understood that the terms so used are interchangeable under appropriate circumstances, such that the embodiments of the present disclosure described herein may be implemented in sequences other than those illustrated or described herein.

As used herein, the term “if” may be construed to mean “when” or “upon” or “in response to determining” depending on the context. For the purpose of brevity and the ease of understandings, the terms used herein to characterize magnitude relationships are “greater than” or “less than”, or “higher than” or “lower than”. However, those skilled in the art may understand that the term “greater than” also covers the meaning of “greater than or equal to”, and the term “less than” also covers the meaning of “less than or equal to”; and the term “higher than” covers the meaning of “higher than or equal to”, and the term “lower than” also covers the meaning of “lower than or equal to”.

An audio encoding/decoding method disclosed in an embodiment of the present disclosure may be applied to various communication systems, for example, a third generation (3G) universal mobile telecommunications system (UMTS), a long term evolution (LTE) system, a fifth generation (5G) mobile communication system, a 5G new radio (NR) system, a sixth generation (6G) mobile communication system, other new future mobile communication systems, or the like. The audio encoding/decoding method disclosed in the embodiments of the present disclosure may also be applied to streaming media transmission systems or over the top (OTT) media transmission systems.

The embodiments of the present disclosure provide an audio encoding method, an audio decoding method, an audio encoding apparatus, an audio decoding apparatus, an electronic device, a non-transitory computer-readable storage medium, a computer program product, and a computer program, so as to solve problems such as waste of transmission and storage media in the process of a multi-channel audio transmission.

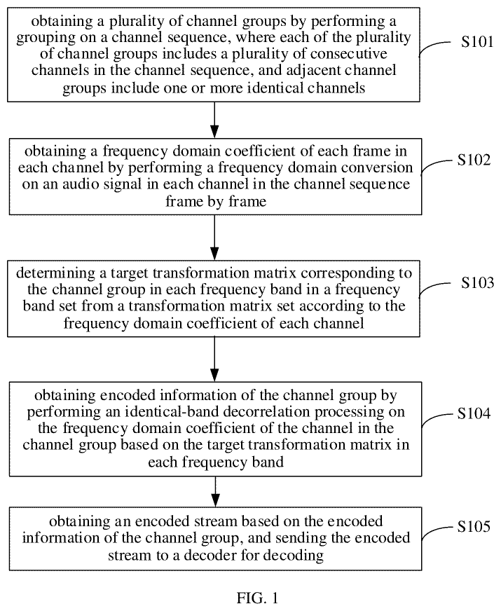

FIG. 1 is a schematic flow chart of an audio encoding method provided in an embodiment of the present disclosure. The audio encoding method may be performed by an encoder. As shown in FIG. 1, the method may include, but is not limited to, steps S101 to S105.

At step S101, a plurality of channel groups are obtained by performing a grouping on a channel sequence, where each of the plurality of channel groups includes a plurality of consecutive channels in the channel sequence, and adjacent channel groups include one or more identical channels.

In an implementation, the encoder may group M channels in the channel sequence to obtain a plurality of channel groups. In an implementation, each channel group includes several consecutive channels in the channel sequence, for example, may include three consecutive channels. In an embodiment of the present disclosure, adjacent channel groups include one or more identical channels. It may be understood that the adjacent channel groups are a first channel group and a second channel group, respectively. The first channel group and the second channel group each include three consecutive channels in the channel sequence, and the first channel group and the second channel group include two identical channels. For example, five channels in the channel sequence are divided into channel group 1, channel group 2, and channel group 3. The channel group 1 includes channel 1, channel 2 and channel 3; the channel group 2 includes channel 2, channel 3 and channel 4; and the channel group 3 includes channel 3, channel 4 and channel 5.

At step S102, a frequency domain coefficient of each frame in each channel is obtained by performing a frequency domain conversion on an audio signal in each channel in the channel sequence frame by frame.

In an embodiment of the present disclosure, the encoder divides the audio signal in each channel in the channel sequence into multiple frames of a fixed length, and performs a modified discrete cosine transformation (MDCT) on each frame to obtain a frequency domain representation of each frame. Based on the frequency domain representation of each frame, the MDCT coefficient of each frame may be extracted from the frequency domain representation as the frequency domain coefficient of each frame.

In an implementation, the channel sequence in the embodiments of the present disclosure includes M channels.

In an implementation, each frame of audio data in each channel may include 2N sampling points, and the sampling rate is fₛ. Each frame after the MDCT transformation may include N frequency points. Accordingly, the spectrum distribution range of the MDCT coefficient is (0, fₛ/2), and the frequency resolution is fₛ/2N.

At step S103, a target transformation matrix corresponding to the channel group in each frequency band in a frequency band set is determined from a transformation matrix set according to the frequency domain coefficient of each channel.

In an implementation, the frequency bands may be divided in advance according to a psychoacoustic frequency band division procedure to obtain a frequency band set, where the frequency band set may include multiple divided frequency bands. For example, the frequency band set may include b divided frequency bands, where b is an integer greater than or equal to 1. Each frequency band in the frequency band set has a different frequency range, and the frequency ranges of adjacent frequency bands are continuous.

In an implementation, after the MDCT transformation is performed on each frame in a channel, the sampling point sequence for each frequency domain coefficient is multiplied by the frequency resolution to determine the frequency value for each frequency domain coefficient.

In an implementation, the formula for calculating the frequency value for any frequency domain coefficient is as follows:

$$f = n * {f}_{s} / 2 N \qquad ( 1 )$$

where n represents an n^{th} sampling point corresponding to any frequency domain coefficient, the value of n ranges from 1 to N, and N is the number of sampling points. The frequency value f corresponding to the frequency domain coefficient may be obtained by formula (1).

In an implementation, the frequency value for the frequency domain coefficient is compared with the frequency range of each frequency band to obtain the frequency range where the frequency domain coefficient is located, so as to determine the frequency domain coefficient in each frequency band.

In an implementation, the cross-correlation coefficient between different channels in the same frequency band is calculated based on the frequency domain coefficients of the channels in the same frequency band. That is, for each frequency band in the frequency band set, the cross-correlation coefficient between any two channels corresponding to the frequency band may be obtained based on the frequency domain coefficients of the channels in the same frequency band.

In an implementation, for any frequency band b in the frequency band set, the cross-correlation coefficient between any two channels in the channel group in the frequency band b may be determined from the cross-correlation coefficient between any two channels corresponding to the frequency band b based on the channels included in the channel group. In an implementation, based on the cross-correlation coefficient between any two channels in the channel group in any frequency band b, the target transformation matrix corresponding to the channel group in the frequency band b is determined from the transformation matrix set. It may be understood that the frequency band set includes B frequency bands, and the target transformation matrix for the channel group in each frequency band may be obtained.

At step S104, encoded information of the channel group is obtained by performing an identical-band decorrelation processing on the frequency domain coefficient of the channel in the channel group based on the target transformation matrix in each frequency band.

In an implementation, the transformation matrix set includes multiple transformation matrices, and each transformation matrix may correspond to a decorrelation mode. In an implementation, the transformation matrix set may include M0, M1, M2, M3, and M4. The specific values of the transformation matrices are as follows:

$$M 0 = \begin{matrix}[ \begin{matrix}1 & 0 & 0 \\ 0 & 1 & 0 \\ 0 & 0 & 1\end{matrix} ] & M 1 =\end{matrix} [ \begin{matrix}\frac{\sqrt{2}}{2} & \frac{\sqrt{2}}{2} & 0 \\ \frac{\sqrt{2}}{2} & - \frac{\sqrt{2}}{2} & 0 \\ 0 & 0 & 1\end{matrix} ]$$

$$M 2 = \begin{matrix}[ \begin{matrix}\frac{\sqrt{2}}{2} & 0 & \frac{\sqrt{2}}{2} \\ 0 & 1 & 0 \\ \frac{\sqrt{2}}{2} & 0 & - \frac{\sqrt{2}}{2}\end{matrix} ] & M 3 = [ \begin{matrix}1 & 0 & 0 \\ 0 & \frac{\sqrt{2}}{2} & \frac{\sqrt{2}}{2} \\ 0 & \frac{\sqrt{2}}{2} & - \frac{\sqrt{2}}{2}\end{matrix} ]\end{matrix}$$

$$M 4 = [ \begin{matrix}\frac{\sqrt{3}}{3} & \frac{\sqrt{3}}{3} & \frac{\sqrt{3}}{3} \\ \frac{\sqrt{2}}{2} & - \frac{\sqrt{2}}{2} & 0 \\ \frac{\sqrt{6}}{6} & \frac{\sqrt{6}}{6} & - \frac{\sqrt{6}}{3}\end{matrix} ] .$$

In an implementation, the decorrelation mode for the channel group in each frequency band may be determined based on the target transformation matrix for the channel group in each frequency band. When the target transformation matrices corresponding to different frequency bands are different, the decorrelation modes corresponding to the different frequency bands are also different. When the target transformation matrices corresponding to different frequency bands are the same, the decorrelation modes corresponding to the different frequency bands are also the same. For example, the target transformation matrix in frequency band 1 is M1, the target transformation matrix in frequency band 2 is M2, and the target transformation matrix in frequency band 3 is M1. Then, the decorrelation modes in frequency band 1 and frequency band 3 are the same, but the decorrelation modes in frequency band 1 and frequency band 3 are different from the decorrelation mode in frequency band 2, respectively.

In an implementation, the frequency domain coefficients of the channels in the channel group are differentiated with frequency bands to obtain the frequency domain coefficient in each frequency band. The frequency domain coefficients of the channels in the channel group in the same frequency band are decorrelated based on the target transformation matrix corresponding to the same frequency band, so as to obtain the encoded information of the channel group.

For example, three consecutive channels included in a channel group are defined, and the three consecutive channels may be labeled as channel L, channel C, and channel R. For any frequency band b in the frequency band set, the target transformation matrix for the channel group in the frequency band b may be determined to be M4. A frequency domain coefficient matrix may be formed by frequency domain coefficients of channel L, channel C and channel R in the frequency band b, and a matrix operation is performed on the frequency domain coefficient matrix for the channel group in the frequency band b and the target transformation matrix M4 corresponding to the frequency band b to obtain first encoded information of the channel group in the frequency band b. That is, the frequency domain coefficients of channel L, channel C and channel R in the channel group in the frequency band b are decorrelated by using the target transformation matrix M4 corresponding to the frequency band b to obtain the encoded information of the channel group in the frequency band b. An identical-band decorrelation processing may be performed on the channel L, channel C and channel R in the channel group to reduce the co-channel interference and reduce the redundancy and transmission costs.

It may be understood that the frequency domain coefficient in the channel group in each frequency band may be decorrelated by using the target transformation matrix corresponding to each frequency band to obtain the encoded information of the channel group in each frequency band. After the encoded information corresponding to each frequency band is obtained, the encoded information of the channel group in the entire frequency band may be obtained based on the encoded information in each frequency band. It may be understood that the encoded information of the channel group includes encoded information of the channel group in all frequency bands.

At step S105, an encoded stream is obtained based on the encoded information of the channel group, and sent to a decoder for decoding.

In an implementation, the encoded information of the channel group may be encoded in a binary format to obtain a binary encoded stream. That is, the encoded information of each channel is converted into binary codes, and the binary codes of all channel groups are connected to form an encoded stream. In an implementation, the encoded stream is sent to a decoder for decoding to restore the original channel signal.

It should be noted that in order for the decoder to implement decoding, the target transformation matrix for the channel group in each frequency band also needs to be sent. In an implementation, the target transformation matrix in each frequency band may be written into the encoded stream and sent together with the encoded information of the channel, or may be sent to the decoder separately from and synchronously with the encoded stream.

In the audio encoded method provided in the embodiments of the present disclosure, an encoder obtains frequency domain coefficients by performing frequency band dividing and grouping on channel signals, and determines, based on the frequency domain coefficient of each channel, the target transformation matrix corresponding to a channel group in each frequency band. The frequency domain coefficients of the channels are further decorrelated according to the target transformation matrix to obtain encoded information of the channel group. The encoded stream is obtained based on the encoded information and sent to a decoder for decoding. In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs.

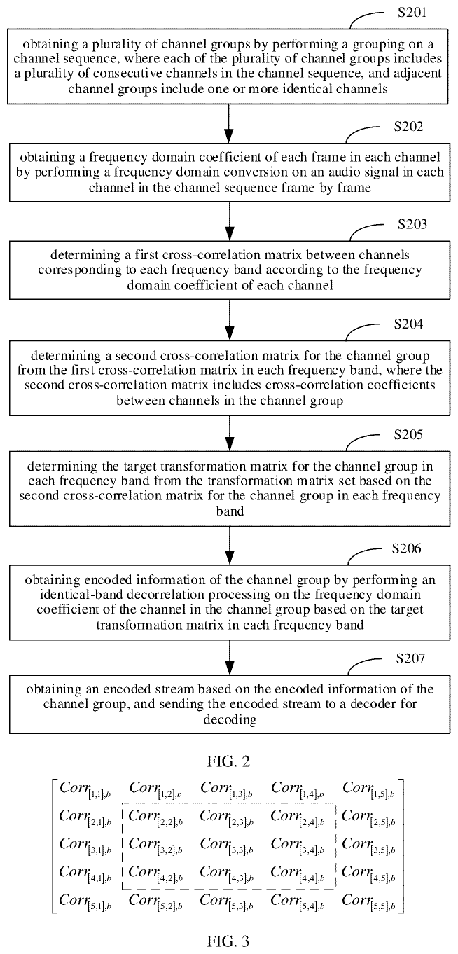

FIG. 2 is a schematic flow chart of an audio encoding method provided in an embodiment of the present disclosure. The audio encoding method may be performed by an encoder. As shown in FIG. 2, the method may include, but is not limited to, steps S201 to S207.

At step S201, a plurality of channel groups are obtained by performing a grouping on a channel sequence, where each of the plurality of channel groups includes a plurality of consecutive channels in the channel sequence, and adjacent channel groups include one or more identical channels.

In an embodiment of the present disclosure, the implementation of step S201 may be performed in any of the ways in the embodiments of the present disclosure, which is not limited here and will not be repeated here.

At step S202, a frequency domain coefficient of each frame in each channel is obtained by performing a frequency domain conversion on an audio signal in each channel in the channel sequence frame by frame.

In an embodiment of the present disclosure, the implementation of step S202 may be performed in any of the ways in the embodiments of the present disclosure, which is not limited here and will not be repeated here.

At step S203, a first cross-correlation matrix between channels corresponding to each frequency band is determined according to the frequency domain coefficient of each channel.

In an implementation, the energy value of any channel in each frequency band is determined according to the frequency domain coefficient of the channel, and the first cross-correlation matrix corresponding to each frequency band is determined according to the energy value of each channel in each frequency band.

In an implementation, the root mean square (RMS) energy of any channel may be calculated according to the frequency domain coefficient of the channel to determine the energy value of each channel in each frequency band. The formula for calculating the RMS energy is as follows:

$${RMS}_{c , b} = sqrt ( {\sum }_{i = 1}^{i = {N}_{c , b}} {X}_{i}^{2} ) , c = 1 … M , b ∈ {Z}^{+} \qquad ( 2 )$$

where c represents an index value of a channel, which ranges from 1 to M, where M is the number of input channels; b is an index value of a frequency band; Xᵢ is the frequency domain coefficient of the corresponding channel; and N_{c,b} is the number of frequency points within the frequency band for the channel.

It should be noted that the number of frequency points may be calculated based on the width of the frequency band and the frequency resolution corresponding to the frequency band.

Typically, the data lengths of individual channels are the same. Then, according to the same frequency band division procedure, the data lengths of different channels in the same frequency band are also the same. Therefore, the number of frequency points in the same frequency band is the same, that is, N_{c,b}=N_{b}.

In an implementation, after the energy value of each channel in each frequency band is obtained, the energy ratio of any two channels in the channel sequence in any frequency band b is obtained. In an implementation, the cross-correlation coefficient between any two channels in any frequency band b is determined according to the energy ratio of the channels in any frequency band b.

In an implementation, the energy ratio Q of any two channels in the channel sequence in any frequency band b is obtained, where the formula for calculating the energy ratio Q is as follows:

$$Q = \frac{{RMS}_{{c}_{1} , {b}_{1}}}{{RMS}_{{c}_{2} , {b}_{2}}} , {c}_{1} = 1 … M , {c}_{2} = 1 … M , {b}_{1} ∈ {Z}^{+} , {b}_{2} ∈ {Z}^{+} \qquad ( 3 )$$

where c represents an index value of a channel, which ranges from 1 to M, where M is the number of input channels; b is the number of the divided frequency bands; c₁ may be the same as or different from c₂, and similarly b₁ may be the same as or different from b₂.

In an implementation, energy discrimination may be performed by using the energy ratio Q, and the cross-correlation coefficient between the channels in any frequency band b may be determined based on the energy discrimination result. If the energy ratio in any frequency band b is less than or equal to a first set threshold, it is determined that the cross-correlation coefficient between the two channels in any frequency band b is zero; and if the energy ratio in any frequency band b is greater than or equal to a second set threshold, it is determined that the cross-correlation coefficient between the two channels in any frequency band b is zero. The first set threshold is less than the second set threshold.

If the energy ratio in any frequency band b is between the first set threshold and the second set threshold, that is, the energy ratio is greater than the first set threshold and less than the second set threshold, the cross-correlation coefficient between the two channels in any frequency band b is determined according to the frequency domain coefficients of the two channels in any frequency band b.

That is, if the energy ratio Q of the two channels in any frequency band b is too large or too small, the cross-correlation coefficient of the two channels is 0; and if the energy ratio Q of the two channels in any frequency band b is between (0.5, 2), the cross-correlation coefficient of the two channels is further calculated.

In an implementation, the cross-correlation coefficient may be determined according to the magnitude of the Q. The formula for calculating the cross-correlation coefficient is as follows:

$${Corr}_{[ x , y ] , b} = {\sum }_{i = 1}^{i = {N}_{b}} {X}_{i} {Y}_{i} , x = 1 … M , y = 1 … M \qquad ( 4 )$$

where [x, y] represents an index value of a channel, b represents an index value of a frequency band, and N_{b} represents the number of frequency points within the frequency band for the channel.

In an implementation, based on the cross-correlation coefficient between any two channels in any frequency band b, a first cross-correlation matrix corresponding to the frequency band b may be obtained. For example, the channel sequence contains M channels, and the first cross-correlation matrix may be obtained as follows:

$$[ \begin{matrix}{Corr}_{[ 1 , 1 ] , b} & {Corr}_{[ 1 , 2 ] , b} & … & {Corr}_{[ 1 , M ] , b} \\ {Corr}_{[ 2 , 1 ] , b} & {Corr}_{[ 2 , 2 ] , b} & … & {Corr}_{[ 2 , M ] , b} \\ … & … & … & … \\ {Corr}_{[ M , 1 ] , b} & {Corr}_{[ M , 2 ] , b} & … & {Corr}_{[ M , M ] , b}\end{matrix} ]$$

where the first row and the first column of the first cross-correlation matrix correspond to channel 1, the second row and the second column of the first cross-correlation matrix correspond to channel 2, and so on. The M^{th} row and the M^{th} column of the first cross-correlation matrix correspond to channel M.

It should be noted that, for each frequency band in a frequency band set, a corresponding first cross-correlation matrix may be determined in the above manner. If the frequency band set includes b frequency bands, then there are b first cross-correlation matrices.

At step S204, a second cross-correlation matrix for the channel group is determined from the first cross-correlation matrix in each frequency band, where the second cross-correlation matrix includes cross-correlation coefficients between channels in the channel group.

In an implementation, according to the M×M first cross-correlation matrix shown above, a second cross-correlation matrix corresponding to the channel group may be extracted from the first cross-correlation matrix based on the channels in the channel group. In an implementation, a channel index of a channel in a channel group is determined, and a second cross-correlation matrix for the channel group is extracted from the first cross-correlation matrix according to the channel index. In an implementation, the channel group includes three channels, a second cross-correlation matrix corresponding to the channel group may be determined from the first cross-correlation matrix based on the cross-correlation coefficient between any two channels included in the channel group. The second cross-correlation matrix is a 3×3 matrix.

For example, the channel sequence includes five channels, which are arranged in order as channel 1, channel 2, channel 3, channel 4, and channel 5. The channel group includes three channels, where channel group 1 may include channel 1, channel 2, and channel 3; channel group 2 may include channel 2, channel 3, and channel 4; and channel group 3 includes channel 3, channel 4, and channel 5. The first cross-correlation matrix is a 5×5 matrix, as shown in FIG. 3. For channel group 2, the matrix elements at the intersection of rows 2 to 4 and columns 2 to 4 may be extracted from the first cross-correlation matrix as the second cross-correlation matrix for channel group 2. For example, the second cross-correlation matrix for the channel group 2 may be the portion within the dashed box of the first cross-correlation matrix as shown in FIG. 3, that is, the second cross-correlation matrix for the channel group 2 is as follows:

$$[ \begin{matrix}{Corr}_{[ 2 , 2 ] , b} & {Corr}_{[ 2 , 3 ] , b} & {Corr}_{[ 2 , 4 ] , b} \\ {Corr}_{[ 3 , 2 ] , b} & {Corr}_{[ 3 , 3 ] , b} & {Corr}_{[ 3 , 4 ] , b} \\ {Corr}_{[ 4 , 2 ] , b} & {Corr}_{[ 4 , 3 ] , b} & {Corr}_{[ 4 , 4 ] , b}\end{matrix} ] .$$

It should be noted that the channel group corresponds to a second cross-correlation matrix in each frequency band.

At step S205, the target transformation matrix for the channel group in each frequency band is determined from the transformation matrix set based on the second cross-correlation matrix for the channel group in each frequency band.

In an implementation, for any frequency band b, if the cross-correlation coefficient between any two channels included in the second cross-correlation matrix in any frequency band b meets a condition for selecting a specified transformation matrix in the transformation matrix set, then the specified transformation matrix is selected as the target transformation matrix in the frequency band b; and if the cross-correlation coefficient between any two channels included in the second cross-correlation matrix in any frequency band b does not meet the condition, then according to a maximum cross-correlation coefficient between the two channels, a transformation matrix other than the specified transformation matrix is selected from the transformation matrix set as the target transformation matrix in the frequency band b.

In an implementation, a cross-correlation coefficient threshold may be set, and a target transformation matrix for the channel group may be determined from the transformation matrix set according to the cross-correlation coefficient threshold. The second cross-correlation matrix for the channel group in each frequency band includes the cross-correlation coefficient between any two channels in the channel group. If the cross-correlation coefficient between any two channels is greater than a set threshold, the specified transformation matrix is selected as the target transformation matrix in any frequency band b; and if the cross-correlation coefficient between any two channels is not greater than the threshold, then according to the maximum cross-correlation coefficient between any two channels, a transformation matrix other than the specified transformation matrix is selected from the transformation matrix set as the target transformation matrix in any frequency band b.

For example, the transformation matrix set may include M0, M1, M2, M3, and M4. The specified transformation matrix may be M4. If the cross-correlation coefficients of three channels are all greater than a threshold, the target transformation matrix is determined to be M4. If the maximum value of the cross-correlation coefficients of three channels is greater than a threshold, the target transformation matrix is determined according to the maximum value.

At step S206, encoded information of the channel group is obtained by performing an identical-band decorrelation processing on the frequency domain coefficient of the channel in the channel group based on the target transformation matrix in each frequency band.

In an embodiment of the present disclosure, the implementation of step S206 may be performed in any of the ways in the embodiments of the present disclosure, which is not limited here and will not be repeated here.

At step S207, an encoded stream is obtained based on the encoded information of the channel group, and sent to a decoder for decoding.

In an embodiment of the present disclosure, the implementation of step S207 may be performed in any of the ways in the embodiments of the present disclosure, which is not limited here and will not be repeated here.

In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs.

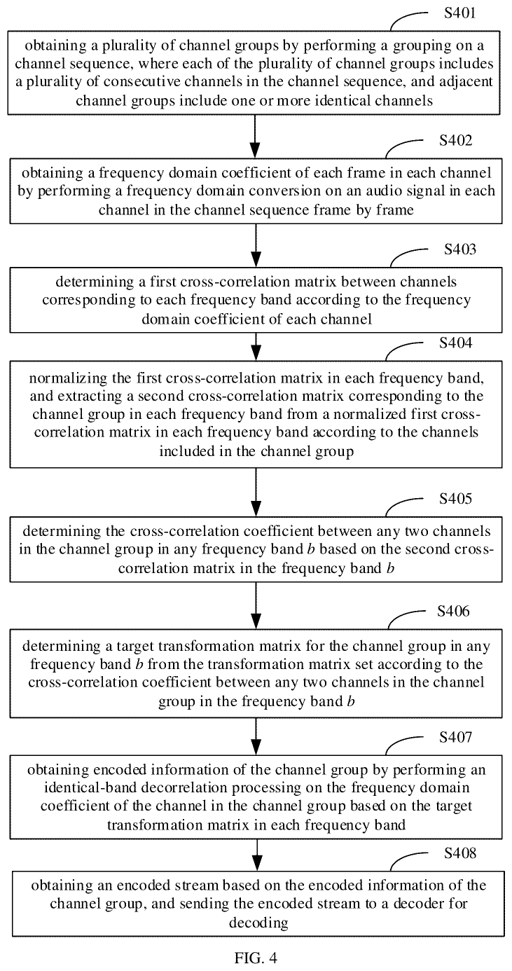

FIG. 4 is a schematic flow chart of an audio encoding method provided in an embodiment of the present disclosure. The audio encoding method may be performed by an encoder. As shown in FIG. 4, the method may include, but is not limited to, steps S401 to S408.

At step S401, a plurality of channel groups are obtained by performing a grouping on a channel sequence, where each of the plurality of channel groups includes a plurality of consecutive channels in the channel sequence, and adjacent channel groups include one or more identical channels.

In an embodiment of the present disclosure, the implementation of step S401 may be performed in any of the ways in the embodiments of the present disclosure, which is not limited here and will not be repeated here.

At step S402, a frequency domain coefficient of each frame in each channel is obtained by performing a frequency domain conversion on an audio signal in each channel in the channel sequence frame by frame.

In the embodiments of the present disclosure, the implementation of step S402 may be performed in any of the ways in the embodiments of the present disclosure, which is not limited here and will not be repeated here.

At step S403, a first cross-correlation matrix between channels corresponding to each frequency band is determined according to the frequency domain coefficient of each channel.

In an embodiment of the present disclosure, the implementation of step S403 may be performed in any of the ways in the embodiments of the present disclosure, which is not limited here and will not be repeated here.

At step S404, the first cross-correlation matrix in each frequency band is normalized, and a second cross-correlation matrix corresponding to the channel group in each frequency band is extracted from a normalized first cross-correlation matrix in each frequency band according to the channels included in the channel group.

In an implementation, the first cross-correlation matrix between channels in each frequency band is normalized to obtain a normalized first cross-correlation matrix in each frequency band, so as to extract the second cross-correlation matrix corresponding to the channel group in each frequency band from the normalized first cross-correlation matrix in each frequency band. It may be understood that the second cross-correlation matrix is a normalized matrix.

In an implementation, a channel identifier associated with an arbitrary matrix element in the first cross-correlation matrix is determined. In an implementation, the normalized matrix element corresponding to the arbitrary matrix element may be determined according to the associated channel identifier. The arbitrary matrix element is a cross-correlation coefficient between two channels, the channel identifier corresponding to a row where the arbitrary matrix element is located may be a channel identifier associated with the arbitrary matrix element, and the channel identifier corresponding to a row where the arbitrary matrix element is located may be another channel identifier associated with the arbitrary matrix element.

As an example, the arbitrary matrix element Corr_{[2,3], b} in the first cross-correlation matrix corresponding to the frequency band b is used for explanation, where the channel identifiers associated with the arbitrary matrix element Corr_{[2,3], b} are 2 and 3, that is, the channels associated with the arbitrary matrix element Corr_{[2,3], b} are channel 2 and channel 3.

The channels associated with the arbitrary matrix element Corr_{[2,3], b} are channel 2 and channel 3, and the normalized matrix elements of the arbitrary matrix element Corr_{[2,3], b} may be determined to be Corr_{[2,2], b} and Corr_{[3,3], b}.

In an implementation, a normalization result of the arbitrary matrix element is obtained according to the arbitrary matrix element and the normalized matrix element. In an implementation, the normalization formula corresponding to the arbitrary matrix element is as follows:

$$\begin{matrix}{Corr}_{{normalize}_{[ x , y ] , b}} = \frac{{Corr}_{[ {x}_{i} , {y}_{j} ] , b}}{{Corr}_{[ {x}_{i} , {x}_{i} ] , b} * {Corr}_{[ {y}_{j} , {y}_{j} ] , b}} , \\ {x}_{i} = 1 … M , {y}_{j} = 1 … M , {Corr}_{[ {x}_{i} , {x}_{i} ] , b} * {Corr}_{[ {y}_{j} , {y}_{j} ] , b} > 0\end{matrix} \qquad ( 5 )$$

where b represents an index value of a frequency band, Corr_{[x}_{ᵢ}_{,y}_{ⱼ}_{],b} represents the arbitrary matrix element, and Corr_{[x}_{ᵢ}_{,x}_{ᵢ}_{]b}*Corr_{[y}_{ⱼ}_{,y}_{ⱼ}_{]b} represents the normalized matrix element.

It should be noted that since the values of the cross-correlation coefficient matrix at symmetric positions along a diagonal line are equal, the cross-correlation coefficients at the lower left of the diagonal line do not need to be calculated, and the elements at the upper right of the diagonal line of the cross-correlation coefficient matrix may be used for normalization calculation. When the above calculation is performed, if the denominator is greater than 0, the normalization calculation is continued; and if the denominator is less than 0, the cross-correlation coefficient at the corresponding position is set to 0. Here, the diagonal line is a diagonal line from the upper left corner to the lower right corner.

At step S405, the cross-correlation coefficient between any two channels in the channel group in any frequency band b is determined based on the second cross-correlation matrix in the frequency band b.

In an implementation, since the elements in the second cross-correlation matrix are the cross-correlation coefficient between any two channels in the channel group in any frequency band b, the cross-correlation coefficient between any two channels in the channel group in the frequency band b may be determined based on the second cross-correlation matrix.

At step S406, a target transformation matrix for the channel group in any frequency band b is determined from the transformation matrix set according to the cross-correlation coefficient between any two channels in the channel group in the frequency band b.

In an implementation, a threshold of the cross-correlation coefficient between any two channels in a channel group in any frequency band b may be set as Thr, and a target transformation matrix may be determined according to a preset condition by comparing the cross-correlation coefficient between any two channels in the channel group with the threshold.

In an implementation, if the cross-correlation coefficient between any two channels meets the condition for selecting a specified transformation matrix in the transformation matrix set, that is, the values of the cross-correlation coefficient between any two channels in the channel group are all greater than Thr, then the specified transformation matrix M4 is selected as the target transformation matrix in any frequency band b.

For example, [L, C, R] are three channels in the channel group. If the cross-correlation coefficient between channel L and channel C, the cross-correlation coefficient between channel L and channel R, and the cross-correlation coefficient between channel C and channel R are all greater than Thr, then the specified transformation matrix M4 is selected as the target transformation matrix in any frequency band b.

In an implementation, if the cross-correlation coefficient between any two channels in any frequency band b does not meet the condition, a transformation matrix other than the specified transformation matrix is selected as the target transformation matrix in any frequency band b based on the maximum cross-correlation coefficient between any two channels.

That is, the maximum cross-correlation coefficient is selected from the three cross-correlation coefficients, namely, the cross-correlation coefficient between channel L and channel C, the cross-correlation coefficient between channel L and channel R, and the cross-correlation coefficient between channel C and channel R. If the maximum cross-correlation coefficient is greater than Thr, the target transformation matrix in any frequency band b is selected from the transformation matrices other than the specified transformation matrix. For example, if the specified transformation matrix is M4, the target transformation matrix is selected from M0 to M3 according to the maximum cross-correlation coefficient.

In an implementation, when the maximum cross-correlation coefficient is greater than Thr, the target transformation matrix is selected according to the formula (6):

$$Mode = \{ \begin{matrix}M 1 , max value is {Corr\_normalize}_{[ L , C ] , b} \\ M 2 , max value is {Corr\_normalize}_{[ L , R ] , b} \\ M 3 , max value is {Corr\_normalize}_{[ C , R ] , b}\end{matrix} . \qquad ( 6 )$$

For example, if the maximum cross-correlation coefficient between any two channels in a channel group in any frequency band b is the cross-correlation coefficient between channel L and channel C, then M1 is selected as the target transformation matrix; if the maximum cross-correlation coefficient between any two channels in a channel group in any frequency band b is the cross-correlation coefficient between channel L and channel R, then M2 is selected as the target transformation matrix; and if the maximum cross-correlation coefficient between any two channels in a channel group in any frequency band b is the cross-correlation coefficient between channel C and channel R, then M3 is selected as the target transformation matrix.

At step S407, encoded information of the channel group is obtained by performing an identical-band decorrelation processing on the frequency domain coefficient of the channel in the channel group based on the target transformation matrix in each frequency band.

In an embodiment of the present disclosure, the implementation of step S407 may be performed in any of the ways in the embodiments of the present disclosure, which is not limited here and will not be repeated here.

At step S408, an encoded stream is obtained based on the encoded information of the channel group, and sent to a decoder for decoding.

In an embodiment of the present disclosure, the implementation of step S408 may be performed in any of the ways in the embodiments of the present disclosure, which is not limited here and will not be repeated here.

In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs.

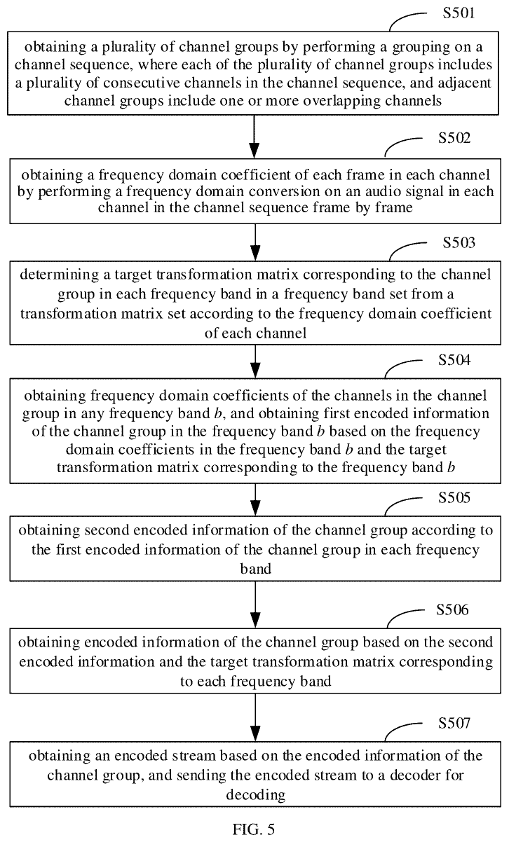

FIG. 5 is a schematic flow chart of an audio encoding method provided in an embodiment of the present disclosure. The audio encoding method may be performed by an encoder. As shown in FIG. 5, the method may include, but is not limited to, steps S501 to S507.

At step S501, a plurality of channel groups are obtained by performing a grouping on a channel sequence, where each of the plurality of channel groups includes a plurality of consecutive channels in the channel sequence, and adjacent channel groups include one or more overlapping channels.

In an embodiment of the present disclosure, the implementation of step S501 may be performed in any of the ways in the embodiments of the present disclosure, which is not limited here and will not be repeated here.

At step S502, a frequency domain coefficient of each frame in each channel is obtained by performing a frequency domain conversion on an audio signal in each channel in the channel sequence frame by frame.

In an embodiment of the present disclosure, the implementation of step S502 may be performed in any of the ways in the embodiments of the present disclosure, which is not limited here and will not be repeated here.

At step S503, a target transformation matrix corresponding to the channel group in each frequency band in a frequency band set is determined from a transformation matrix set according to the frequency domain coefficient of each channel.

In an embodiment of the present disclosure, the implementation of step S503 may be performed in any of the ways in the embodiments of the present disclosure, which is not limited here and will not be repeated here.

At step S504, frequency domain coefficients of the channels in the channel group in any frequency band b are obtained, and first encoded information of the channel group in the frequency band b is obtained based on the frequency domain coefficients in the frequency band b and the target transformation matrix corresponding to the frequency band b.

In an implementation, for a first channel group, the first channel group includes channel 1, channel 2 and channel 3, and first encoded information of the first channel group in any frequency band b is obtained based on frequency domain coefficients of channels in the first channel group in the frequency band b, and according to the frequency domain coefficients in the frequency band b and the target transformation matrix corresponding to the frequency band b, where the first encoded information includes center information M₁, side information S₁, and first information T₁ of the first channel group.

It should be noted that, for each remaining channel group except the first channel group, first encoded information of the remaining channel group in any frequency band b is obtained based on frequency domain coefficients of channels in the remaining channel group in the frequency band b, and according to the frequency domain coefficients in the frequency band b and the target transformation matrix corresponding to the frequency band b, where the first encoded information includes first information Tᵢ of the remaining channel group.

It may be understood that the first encoded information of the first channel group includes all of the center information, the side information and the first information, and the first encoded information of the remaining channel groups may only include the first information.

The formula for calculating encoded information of a channel group is as follows:

$$[ \begin{matrix}L & C & R\end{matrix} ] * M = [ \begin{matrix}M & S & T\end{matrix} ] \qquad ( 7 )$$

where [L, C, R] are three channels in a channel group, M is the target transformation matrix determined according to the frequency domain coefficients, [M S T] is the encoded information of the channel group.

It should be noted that, when decorrelation calculation is performed, a first decorrelation encoding unit completely outputs the encoded information [M S T], and the remaining encoding units only output the first information [T].

At step S505, second encoded information of the channel group is obtained according to the first encoded information of the channel group in each frequency band.

In an implementation, the target transformation matrix for the channel group may be determined according to the first encoded information of the channel group in each frequency band, and a decorrelation mode for the channel group in each frequency band, that is, the second encoded information of the channel group, may be determined based on the target transformation matrix.

It may be understood that when the target transformation matrices corresponding to different frequency bands are different, the decorrelation modes corresponding to the different frequency bands are also different. When the target transformation matrices corresponding to different frequency bands are the same, the decorrelation modes corresponding to the different frequency bands are also the same.

At step S506, encoded information of the channel group is obtained based on the second encoded information and the target transformation matrix corresponding to each frequency band.

In an implementation, decorrelation processing may be performed on the frequency domain coefficients of the channel group in each frequency band according to the second encoded information by using the target transformation matrix corresponding to each frequency band, so as to obtain encoded information of the channel group in each frequency band. After the encoded information corresponding to each frequency band is obtained, the encoded information of the channel group in the entire frequency band may be obtained according to the encoded information in each frequency band. It may be understood that the encoded information of the channel group includes encoded information of the channel group in all frequency bands.

At step S507, an encoded stream is obtained based on the encoded information of the channel group, and sent to a decoder for decoding.

In an embodiment of the present disclosure, the implementation of step S507 may be performed in any of the ways in the embodiments of the present disclosure, which is not limited here and will not be repeated here.

In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs.

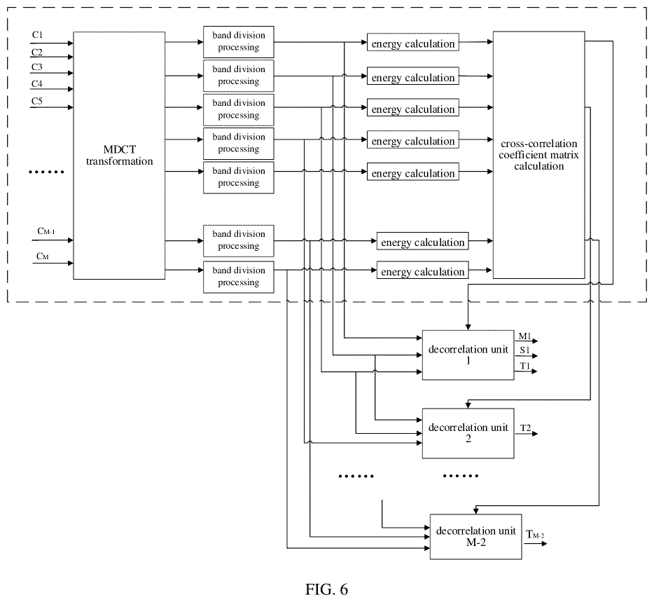

As shown in FIG. 6, a possible encoding flow chart in an embodiment of the present disclosure is shown. The MDCT transformation is performed on an audio signal in each channel to obtain MDCT coefficients (frequency domain coefficients) of each frame in each channel. Then, the channel signal is input into a band division processing unit for frequency band division to obtain frequency domain coefficients in each frequency band. Then, the energy value of the channel in each frequency band is calculated by an energy calculation unit. The energy value is input into a cross-correlation calculation unit to obtain the cross-correlation coefficient between the channels in each frequency band, thereby obtaining a first cross-correlation matrix between the channels in each frequency band. It may be understood that each channel group corresponds to a decorrelation unit, and frequency domain coefficients of three channels in the channel group and the first cross-correlation matrix in each frequency band are input into the decorrelation unit. The decorrelation unit performs an identical-band decorrelation processing on the channel group to obtain the encoded information of the channel group. As shown in FIG. 6, the band division results of the frequency domain coefficients of channel 1, channel 2, and channel 3 in the first channel group, and the first cross-correlation matrix in each frequency band are input into a decorrelation unit 1, such that the decorrelation unit 1 performs an identical-band decorrelation processing and outputs the encoded information of channel group 1, and the encoded information of channel group 1 includes center information M1, side information S₁, and first information T₁. The band division results of the frequency domain coefficients of channel 2, channel 3, and channel 4 in channel group 2, and the first cross-correlation matrix in each frequency band are input into a decorrelation unit 2, such that the decorrelation unit 2 performs an identical-band decorrelation processing and outputs the encoded information of channel group 2, and the encoded information of channel group 2 includes the first information T₂. The band division results of the frequency domain coefficients of channel 3, channel 4 and channel 5 in channel group 3, and the first cross-correlation matrix in each frequency band are input into a decorrelation unit 3, such that the decorrelation unit 3 performs an identical-band decorrelation processing and outputs the encoded information of channel group 3, and the encoded information of channel group 3 includes T₃; and so on. For the last channel group M−2, the band division results of the frequency domain coefficients of channel M−2, channel M−1 and channel M in channel group M−2, and the first cross-correlation matrix in each frequency band are input into a decorrelation unit M−2, such that the decorrelation unit M−2 performs an identical-band decorrelation processing and outputs the encoded information of channel group M−2, and the encoded information of channel group M−2 includes T_{M-2}.

In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs.

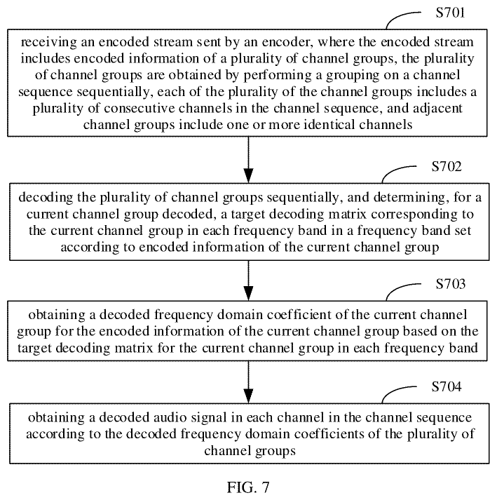

FIG. 7 is a schematic flow chart of an audio decoding method provided in an embodiment of the present disclosure. The audio decoding method may be performed by a decoder. As shown in FIG. 7, the method may include, but is not limited to, steps S701 to S704.

At step S701, an encoded stream sent by an encoder is received, where the encoded stream includes encoded information of a plurality of channel groups.

In an embodiment of the present disclosure, the plurality of channel groups are obtained by performing a grouping on a channel sequence sequentially, each of the plurality of the channel groups includes a plurality of consecutive channels in the channel sequence, and adjacent channel groups include one or more identical channels.

In the embodiments of the present disclosure, the decoder receives the encoded stream sent by the encoder, reads the encoded information of the plurality of channel groups from the encoded stream, and performs an inverse transformation on the input channel signal to obtain the original channel signal.

As described in the above embodiments, the encoder side may group M channels in the channel sequence to obtain a plurality of channel groups. Each channel group contains three consecutive channels in the channel sequence, and adjacent channel groups include one or more identical channels. Regarding the process of encoding the channel group by the encoder, the specific process may be found in the above embodiments and will not be repeated here.

At step S702, the plurality of channel groups are decoded sequentially, and for a current channel group decoded, a target decoding matrix corresponding to the current channel group in each frequency band in a frequency band set is determined according to encoded information of the current channel group.

In an implementation, second encoded information of the channel group in the entire frequency band may be obtained from the encoded information. The second encoded information includes the first encoded information in each frequency band and a target transformation matrix corresponding to each frequency band. For any frequency band b in a frequency band set, according to the target transformation matrix in any frequency band b, the target decoding matrix for the current channel group in any frequency band b is obtained by querying the correspondence between the transformation matrices and the decoding matrices.

It should be noted that the transformation matrices correspond to the decoding matrices in a one-to-one manner. In an implementation, the decoding matrices may include the following matrices:

$$J 0 = \begin{matrix}[ \begin{matrix}1 & 0 & 0 \\ 0 & 1 & 0 \\ 0 & 0 & 1\end{matrix} ] & J 1 =\end{matrix} [ \begin{matrix}\frac{\sqrt{2}}{2} & \frac{\sqrt{2}}{2} & 0 \\ \frac{\sqrt{2}}{2} & - \frac{\sqrt{2}}{2} & 0 \\ 0 & 0 & 1\end{matrix} ]$$

$$J 2 = \begin{matrix}[ \begin{matrix}\frac{\sqrt{2}}{2} & 0 & \frac{\sqrt{2}}{2} \\ 0 & 1 & 0 \\ \frac{\sqrt{2}}{2} & 0 & - \frac{\sqrt{2}}{2}\end{matrix} ] & J 3 = [ \begin{matrix}1 & 0 & 0 \\ 0 & \frac{\sqrt{2}}{2} & \frac{\sqrt{2}}{2} \\ 0 & \frac{\sqrt{2}}{2} & - \frac{\sqrt{2}}{2}\end{matrix} ]\end{matrix}$$

$$J 4 = [ \begin{matrix}\frac{\sqrt{3}}{3} & \frac{\sqrt{2}}{2} & \frac{\sqrt{6}}{6} \\ \frac{\sqrt{3}}{3} & - \frac{\sqrt{2}}{2} & \frac{\sqrt{6}}{6} \\ \frac{\sqrt{3}}{3} & 0 & - \frac{\sqrt{6}}{3}\end{matrix} ] .$$

For example, the transformation matrix M₀ corresponds to the decoding matrix J₀, the transformation matrix M₁ corresponds to the decoding matrix J₁, the transformation matrix M₂ corresponds to the decoding matrix J₂, the transformation matrix M₃ corresponds to the decoding matrix J₃, and the transformation matrix M₄ corresponds to the decoding matrix J₄. If the target transformation matrix for the current channel group is M₄, the target decoding matrix for the current channel group in any frequency band b is J₄.

At step S703, a decoded frequency domain coefficient of the current channel group is obtained for the encoded information of the current channel group based on the target decoding matrix for the current channel group in each frequency band.

In an implementation, the encoded information of the current channel group includes second encoded information of the channel group in the entire frequency band, and the second encoded information includes first encoded information of the channel group in each frequency band.

For any frequency band b in the frequency band set, based on the target decoding matrix corresponding to the frequency band b, the first encoded information in the frequency band b is decoded to obtain the first decoded frequency domain coefficient of the current channel group in the frequency band b. In an implementation, based on the first decoded frequency domain coefficient in each frequency band, the decoded frequency domain coefficient in the channel group in the entire frequency band may be obtained.

At step S704, a decoded audio signal in each channel in the channel sequence is obtained according to the decoded frequency domain coefficients of the plurality of channel groups. In an implementation, a frequency domain to time domain conversion may be performed on signals in the channel groups according to the decoded frequency domain coefficients of the plurality of channel groups. In an implementation, an inverse MDCT transformation may be used to convert the frequency domain signals in the channels into time domain signals based on the decoded frequency domain coefficients, thereby obtaining decoded audio signals in the channels.

In the audio decoding method provided in the embodiments of the present disclosure, the decoder receives the encoded stream sent by the encoder and obtains the encoded information of each channel group therefrom. The encoded information is decoded by a decoding unit in the order of multiple channel groups to obtain the decoded frequency domain coefficient of each channel group, and a frequency domain to time domain conversion is performed on the decoded frequency domain coefficient of each channel group to obtain a decoded audio signal in each channel. During the decoding process, the decoder uses frequency division decoding similar to that on the encoder side to restore the multi-channel audio signal. Since the encoder performs the compression, the multi-channel signal is easier to transmit, and it is possible to save a transmission space.

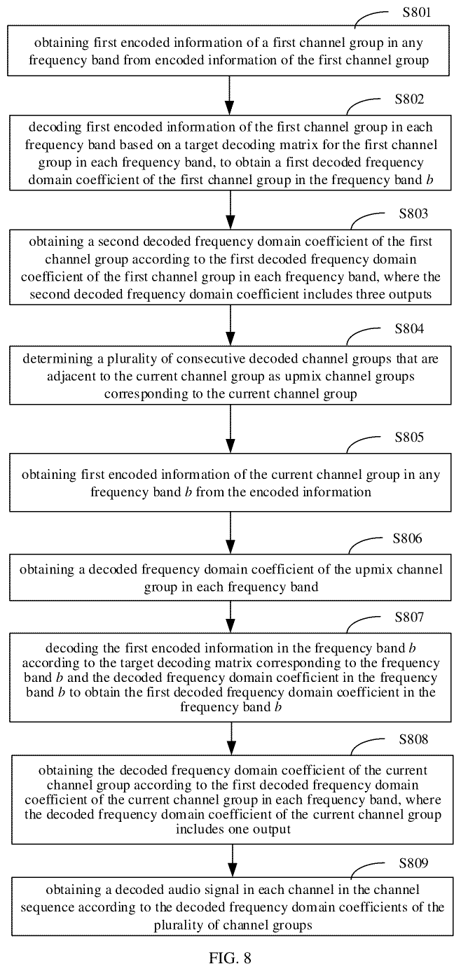

FIG. 8 is a schematic flow chart of an audio decoding method provided in an embodiment of the present disclosure. The audio decoding method may be performed by a decoder. As shown in FIG. 8, the method may include, but is not limited to, steps S801 to S809.

At step S801, first encoded information of a first channel group in any frequency band b is obtained from encoded information of the first channel group.

In an implementation, each channel group includes three consecutive channels, where the first channel group includes channel 1, channel 2, and channel 3. In an implementation, encoded information of the first channel group may be obtained from the encoded stream, the encoded information of the first channel group includes first encoded information of the first channel group in each frequency band, and the first encoded information at least includes center information M₁, side information S₁, and first information T₁ of the first channel group.

At step S802, first encoded information of the first channel group in each frequency band is decoded based on a target decoding matrix for the first channel group in each frequency band, to obtain a first decoded frequency domain coefficient of the first channel group in the frequency band b.

At step S803, a second decoded frequency domain coefficient of the first channel group is obtained according to the first decoded frequency domain coefficient of the first channel group in each frequency band, where the second decoded frequency domain coefficient includes three outputs.

In an implementation, the decoder may obtain the target transformation matrix for the first channel group in any frequency band b from the encoded information corresponding to the first channel group. In an implementation, a correspondence between transformation matrices and decoding matrices is pre-established. In an implementation, a target decoding matrix for the first channel group in any frequency band b may be determined based on the target transformation matrix in any frequency band b.

The first encoded information in any frequency band b is inversely transformed based on the target decoding matrix in any frequency band b to obtain the first decoded frequency domain coefficient of the first channel group in any frequency band b.

In an implementation, for any frequency band b in the frequency band set, first encoded information in any frequency band b is decoded based on a target decoding matrix corresponding to the frequency band b to obtain a first decoded frequency domain coefficient of the first channel group in the frequency band b. It may be understood that the first encoded information of the first channel group includes M₁ S₁ T₁, and after decoding, the first decoded frequency domain coefficient in any frequency band b includes three outputs, and the first decoded frequency domain coefficient may include [ [symbol] [symbol] [symbol] ].

In an implementation, the decoded frequency domain coefficient of the first channel group in the entire frequency band may be obtained based on the first decoded frequency domain coefficient in each frequency band, where the decoded frequency domain coefficient of the first channel group in the entire frequency band includes three outputs [ [symbol] [symbol] [symbol] ].

In an implementation, the decoding formula for the first channel group is as follows:

$$[ \begin{matrix}{M}_{1} & {S}_{1} & {T}_{1}\end{matrix} ] * J = [ \begin{matrix}\text{?} & \text{?} & \text{?}\end{matrix} ] \qquad ( 8 )$$

where [M₁ S₁ T₁] represents the second encoded information of the first channel group, J is the target decoding matrix, and [ [symbol] [symbol] [symbol] ] represents three decoded frequency domain coefficients of the first channel group.

At step S804, a plurality of consecutive decoded channel groups that are adjacent to the current channel group are determined as upmix channel groups corresponding to the current channel group.

In an implementation, when the current channel group is a channel group other than the first channel group in the plurality of channel groups, a plurality of consecutive decoded channel groups that are adjacent to the current channel group may be determined and used as upmix channel groups corresponding to the current channel group for decoding operations. In an implementation, the plurality of decoded channel groups include two channel groups.

For example, if the current channel group is channel group 2, the corresponding upmix channel group includes the decoded frequency domain coefficients at the last two outputs of channel group 1; if the current channel group is channel group 3, the corresponding upmix channel group includes the decoded frequency domain coefficients at the last one output of channel group 1 and one decoded frequency domain coefficient output by channel group 2; and if the current channel group is channel group 4, the corresponding upmix channel group includes one decoded frequency domain coefficient output by channel group 2 and one decoded frequency domain coefficient output by channel group 3.

At step S805, first encoded information of the current channel group in any frequency band b is obtained from the encoded information.

It may be seen based on the encoding process at the encoder side that the output of each channel group starting from channel group 2 is one output. The decoder may obtain first encoded information of the current channel group in any frequency band b from the encoded information of the current channel group. The first encoded information is first information Tᵢ of the current channel group in any frequency band b.

At step S806, a decoded frequency domain coefficient of the upmix channel group in each frequency band is obtained.

In an implementation, a target transformation matrix for the current upmix channel group in each frequency band may be determined from the encoded information received from the decoder, and a target decoding matrix for the upmix channel group may be determined based on the target transformation matrix. The decoder performs an inverse transformation on the target decoding matrix to obtain the decoded frequency domain coefficient of the upmix channel group in each frequency band.

At step S807, the first encoded information in the frequency band b is decoded according to the target decoding matrix corresponding to the frequency band b and the decoded frequency domain coefficient in the frequency band b to obtain the first decoded frequency domain coefficient in the frequency band b.

In an implementation, the decoder obtains the target transformation matrix for the current channel group in each frequency band from the encoded information, and then determines the target decoding matrix for the current channel group in each frequency band based on the target transformation matrix.

For any frequency band b in a frequency band set, the first encoded information Tᵢ in any frequency band b and the first decoded frequency domain coefficient of the upmix channel group in any frequency band b are decoded based on the target decoding matrix in any frequency band b, so as to obtain the first decoded frequency domain coefficient of the current channel group in any frequency band b.

It may be understood that the first encoded information of the current channel group includes the first information Tᵢ, and after decoding, the first decoded frequency domain coefficient in any frequency band b includes one output, and the first decoded frequency domain coefficient may include [ [symbol] ].

At step S808, the decoded frequency domain coefficient of the current channel group is obtained according to the first decoded frequency domain coefficient of the current channel group in each frequency band, where the decoded frequency domain coefficient of the current channel group includes one output.

In an implementation, the decoded frequency domain coefficient of the first channel group in the entire frequency band may be obtained based on the first decoded frequency domain coefficient in each frequency band, where the decoded frequency domain coefficient of the first channel group in the entire frequency band includes three outputs [ [symbol] ].

In an implementation, the decoding formula for the current channel group i is as follows:

$$[ \begin{matrix}\text{?} & \text{?} & {T}_{i}\end{matrix} ] * J = [ \begin{matrix}\text{?} & \text{?} & \text{?}\end{matrix} ] \qquad ( 9 )$$

where [ [symbol] ] represents one decoded frequency domain coefficient output by the (i−2)^{th} channel group (upmix channel group), [ [symbol] ] represents one decoded frequency domain coefficient output by the (i−2)^{th} channel group (upmix channel group), Tᵢ represents the first encoded information of the current channel group i, J is the target decoding matrix, and [symbol] represents one decoded frequency domain coefficient output by the current channel group.

It should be noted that since a different encoding mode is used for the current channel group and the decoding unit only outputs one decoded frequency domain coefficient, only the value of Tᵢ is needed, so the values of the decoding matrix J are also different. The specific values are as follows:

$$J 0 = \begin{matrix}[ \begin{matrix}* & * & 0 \\ * & * & 0 \\ * & * & 1\end{matrix} ] & J 1 =\end{matrix} [ \begin{matrix}* & * & 0 \\ * & * & 0 \\ * & * & 1\end{matrix} ]$$

$$J 2 = \begin{matrix}[ \begin{matrix}* & * & 1 \\ * & * & 0 \\ * & * & - \sqrt{2}\end{matrix} ] & J 3 = [ \begin{matrix}* & * & 0 \\ * & * & 1 \\ * & * & - \sqrt{2}\end{matrix} ]\end{matrix}$$

$$J 4 = [ \begin{matrix}* & * & \frac{\sqrt{2}}{2} \\ * & * & 0 \\ * & * & - \frac{\sqrt{6}}{2}\end{matrix} ]$$

where * represents no meaning.

At step S809, a decoded audio signal in each channel in the channel sequence is obtained according to the decoded frequency domain coefficients of the plurality of channel groups.

In an embodiment of the present disclosure, the implementation of step S809 may be performed in any of the ways in the embodiments of the present disclosure, which is not limited here and will not be repeated here.

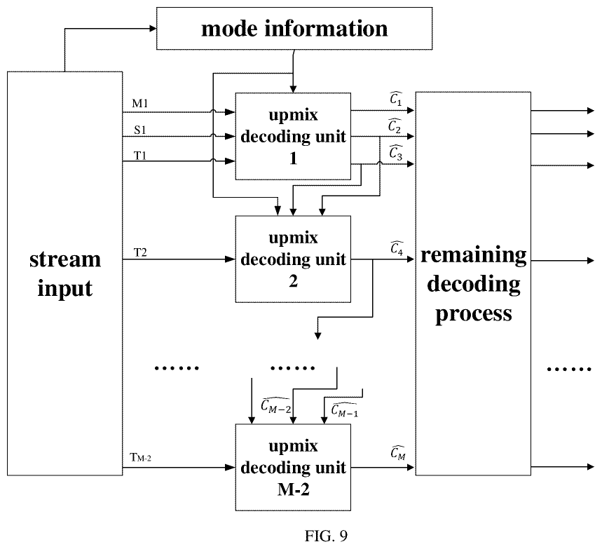

As shown in the decoding flow chart of FIG. 9, decoding at the decoding end needs to be performed sequentially according to the decoding units. The upmix decoding unit 1 is the first upmix decoding unit. The first encoded information [M₁ S₁ T₁] is input into the first upmix decoding unit, and three decoded frequency domain coefficients that are output are [ [symbol] [symbol] [symbol] ]. The first encoded information T₂ and the decoded frequency domain coefficients [ [symbol] ] and [ [symbol] ] output by the first upmix decoding unit are input into the second upmix decoding unit, and the output decoded frequency domain coefficient is [ [symbol] ]. The first encoded information T₃, the decoded frequency domain coefficient [ [symbol] ] output by the first upmix decoding unit, and the decoded frequency domain coefficient [ [symbol] ] output by the second upmix decoding unit are input into the third upmix decoding unit, and the output decoded frequency domain coefficient is [ [symbol] ]. The first encoded information Tᵢ, the decoded frequency domain coefficient [ [symbol] ] output by the (i−2)^{th} upmix decoding unit, and the decoded frequency domain coefficient [ [symbol] ] output by the (i−1)^{th} upmix decoding unit are input to the i^{th} upmix decoding unit, and the output decoded frequency domain coefficient is [ [symbol] ]. Similarly, the first encoded information T_{M-2}, the decoded frequency domain coefficient [ [symbol] ] output by the (M−4)^{th} upmix decoding unit, and the decoded frequency domain coefficient [ [symbol] ] output by the (M−3)^{th} upmix decoding unit are input to the (M−2)^{th} upmix decoding unit, and the output decoded frequency domain coefficient is [ [symbol] ].

In the embodiments of the present disclosure, during the decoding process, the decoder uses frequency division decoding similar to that on the encoder side to restore the multi-channel audio signal. Since the encoder performs the compression, the multi-channel signal is easier to transmit, and it is possible to save a transmission space.

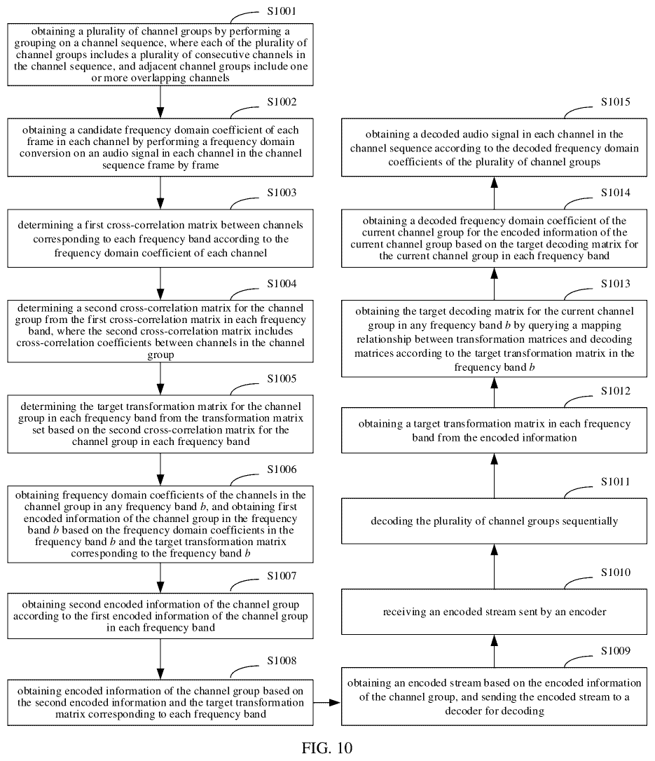

FIG. 10 is a schematic flow chart of an audio coding method provided in an embodiment of the present disclosure. As shown in FIG. 10, the method may include, but is not limited to, steps S1001 to S1015.

At step S1001, a plurality of channel groups are obtained by performing a grouping on a channel sequence, where each of the plurality of channel groups includes a plurality of consecutive channels in the channel sequence, and adjacent channel groups include one or more overlapping channels.

At step S1002, a candidate frequency domain coefficient of each frame in each channel is obtained by performing a frequency domain conversion on an audio signal in each channel in the channel sequence frame by frame.

At step S1003, a first cross-correlation matrix between channels corresponding to each frequency band is determined according to the frequency domain coefficient of each channel.

At step S1004, a second cross-correlation matrix for the channel group is determined from the first cross-correlation matrix in each frequency band, where the second cross-correlation matrix includes cross-correlation coefficients between channels in the channel group.

At step S1005, a target transformation matrix for the channel group in each frequency band is determined from a transformation matrix set based on the second cross-correlation matrix for the channel group in each frequency band.

At step S1006, frequency domain coefficients of the channels in the channel group in any frequency band b are obtained, and first encoded information of the channel group in the frequency band b is obtained based on the frequency domain coefficients in the frequency band b and the target transformation matrix corresponding to the frequency band b.

At step S1007, second encoded information of the channel group is obtained according to the first encoded information of the channel group in each frequency band.

At step S1008, encoded information of the channel group is obtained based on the second encoded information and the target transformation matrix corresponding to each frequency band.

At step S1009, an encoded stream is obtained based on the encoded information of the channel group, and sent to a decoder for decoding.

At step S1010, the encoded stream sent by an encoder is received.

At step S1011, the plurality of channel groups are decoded sequentially.

At step S1012, a target transformation matrix in each frequency band is obtained from the encoded information.

At step S1013, the target decoding matrix for the current channel group in any frequency band b is obtained by querying a mapping relationship between transformation matrices and decoding matrices according to the target transformation matrix in the frequency band b.

At step S1014, a decoded frequency domain coefficient of the current channel group is obtained for the encoded information of the current channel group based on the target decoding matrix for the current channel group in each frequency band.

At step S1015, a decoded audio signal in each channel in the channel sequence is obtained according to the decoded frequency domain coefficients of the plurality of channel groups.

In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs. During the decoding process, the decoder uses frequency division decoding similar to that on the encoder side to restore the multi-channel audio signal.

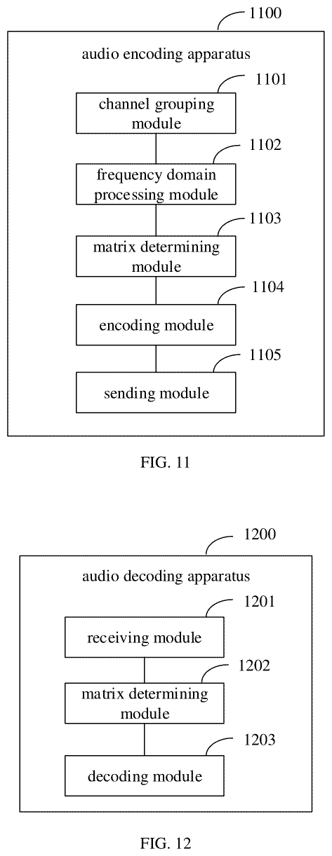

FIG. 11 is a block diagram illustrating an audio encoding apparatus according to an illustrative embodiment. Referring to FIG. 11, the audio encoding apparatus 1100 according to an embodiment of the present disclosure includes a channel grouping module 1101, a frequency domain processing module 1102, a matrix determining module 1103, an encoding module 1104 and a sending module 1105.

The channel grouping module 1101 is configured to obtain a plurality of channel groups by performing a grouping on a channel sequence, where each of the plurality of the channel groups includes a plurality of consecutive channels in the channel sequence, and adjacent channel groups include one or more identical channels.

The frequency domain processing module 1102 is configured to obtain a frequency domain coefficient of each frame in each channel by performing a frequency domain conversion on an audio signal in each channel in the channel sequence frame by frame.

The matrix determining module 1103 is configured to determine a target transformation matrix corresponding to the channel group in each frequency band in a frequency band set from a transformation matrix set according to the frequency domain coefficient of each channel.

The encoding module 1104 is configured to obtain encoded information of the channel group by performing an identical-band decorrelation processing on the frequency domain coefficient of the channel in the channel group based on the target transformation matrix in each frequency band.

The sending module 1105 is configured to obtain an encoded stream based on the encoded information of the channel group, and send the encoded stream to a decoder for decoding.

In an embodiment of the present disclosure, the matrix determining module 1103 is further configured to determine a first cross-correlation matrix between channels corresponding to each frequency band according to the frequency domain coefficient of each channel; determine a second cross-correlation matrix for the channel group from the first cross-correlation matrix in each frequency band, where the second cross-correlation matrix includes cross-correlation coefficients between channels in the channel group; and determine the target transformation matrix for the channel group in each frequency band from the transformation matrix set based on the second cross-correlation matrix for the channel group in each frequency band.

In an embodiment of the present disclosure, the encoding module 1104 is further configured to: obtain frequency domain coefficients of the channels in the channel group in any frequency band b, and obtain first encoded information of the channel group in the frequency band b based on the frequency domain coefficients in the frequency band b and the target transformation matrix corresponding to the frequency band b; obtain second encoded information of the channel group according to the first encoded information of the channel group in each frequency band; and obtain the encoded information of the channel group based on the second encoded information and the target transformation matrix corresponding to each frequency band.

In an embodiment of the present disclosure, the matrix determining module 1103 is further configured to: determine, based on the second cross-correlation matrix in any frequency band b, the cross-correlation coefficient between any two channels in the channel group in the frequency band b; and determine, according to the cross-correlation coefficient between any two channels in the channel group in the frequency band b, the target transformation matrix for the channel group in the frequency band b from the transformation matrix set.

In an embodiment of the present disclosure, the matrix determining module 1103 is further configured to: in a case where the cross-correlation coefficient between the two channels meets a condition for selecting a specified transformation matrix in the transformation matrix set, select the specified transformation matrix as the target transformation matrix in the frequency band b; and in a case where the cross-correlation coefficient between the two channels does not meet the condition, according to a maximum cross-correlation coefficient between the two channels, select a transformation matrix other than the specified transformation matrix from the transformation matrix set as the target transformation matrix in the frequency band b.

In an embodiment of the present disclosure, the matrix determining module 1103 is further configured to: determine an energy value of any channel in each frequency band according to the frequency domain coefficient of the channel; and determine the first cross-correlation matrix corresponding to each frequency band according to the energy value of each channel in each frequency band.

In an embodiment of the present disclosure, the matrix determining module 1103 is further configured to: obtain an energy ratio of any two channels in the channel sequence in any frequency band b; in a case where the energy ratio in the frequency band b is less than or equal to a first set threshold, or the energy ratio in the frequency band b is greater than or equal to a second set threshold, determine that the cross-correlation coefficient between the two channels in the frequency band b is zero, where the first set threshold is less than the second set threshold; in a case where the energy ratio in the frequency band b is between the first set threshold and the second set threshold, determine the cross-correlation coefficient of the two channels in the frequency band b according to the frequency domain coefficients of the two channels in the frequency band b; and obtain the first cross-correlation matrix corresponding to the frequency band b based on the cross-correlation coefficient of the two channels in the frequency band b.

In an embodiment of the present disclosure, the matrix determining module 1103 is further configured to: normalize the first cross-correlation matrix in each frequency band, and extract the second cross-correlation matrix corresponding to the channel group in each frequency band from a normalized first cross-correlation matrix in each frequency band according to the channels included in the channel group.

In an embodiment of the present disclosure, the matrix determining module 1103 is further configured to: determine a channel identifier associated with an arbitrary matrix element in the first cross-correlation matrix; determine a normalized matrix element corresponding to the arbitrary matrix element according to the channel identifier associated; and obtain a normalization result of the arbitrary matrix element according to the arbitrary matrix element and the normalized matrix element.

In an embodiment of the present disclosure, the encoding module 1104 is further configured to: for a first channel group, obtain first encoded information of the first channel group in the frequency band b based on frequency domain coefficients of channels in the first channel group in the frequency band b, and according to the frequency domain coefficients in the frequency band b and the target transformation matrix corresponding to the frequency band b, where the first encoded information includes center information, side information, and first information of the first channel group; and for each remaining channel group except the first channel group, obtain first encoded information of the remaining channel group in the frequency band b based on frequency domain coefficients of channels in the remaining channel group in the frequency band b, and according to the frequency domain coefficients in the frequency band b and the target transformation matrix corresponding to the frequency band b, where the first encoded information includes first information of the remaining channel group.

In an embodiment of the present disclosure, the channel grouping module 1101 is further configured to: determine that the adjacent channel groups include a first channel group and a second channel group, where the first channel group and the second channel group each include three consecutive channels in the channel sequence, and the first channel group and the second channel group include two identical channels.

In the embodiments of the present disclosure, the frequency domain coefficient in the channel group in each frequency band is encoded by using the target transformation matrix, thereby achieving the compression of audio signals in multiple channels, reducing the redundancy between multiple channels, reducing the burden on the encoder, and reducing transmission and storage costs.

FIG. 12 is a block diagram illustrating an audio encoding apparatus according to an illustrative embodiment. Referring to FIG. 12, the audio decoding apparatus 1200 according to an embodiment of the present disclosure includes a receiving module 1201, a matrix determining module 1202, and a decoding module 1203.

The receiving module 1201 is configured to receive an encoded stream sent by an encoder, where the encoded stream includes encoded information of a plurality of channel groups, the plurality of channel groups are obtained by performing a grouping on a channel sequence sequentially, each of the plurality of the channel groups includes a plurality of consecutive channels in the channel sequence, and adjacent channel groups include one or more identical channels.

The matrix determining module 1202 is configured to decode the plurality of channel groups sequentially, and determine, for a current channel group decoded, a target decoding matrix corresponding to the current channel group in each frequency band in a frequency band set according to encoded information of the current channel group.

The decoding module 1203 is configured to obtain a decoded frequency domain coefficient of the current channel group for the encoded information of the current channel group based on the target decoding matrix for the current channel group in each frequency band, and obtain a decoded audio signal in each channel in the channel sequence according to the decoded frequency domain coefficients of the plurality of channel groups.

In an embodiment of the present disclosure, the matrix determining module 1202 is further configured to obtain a target transformation matrix in each frequency band from the encoded information; and obtain the target decoding matrix for the current channel group in any frequency band b by querying a mapping relationship between transformation matrices and decoding matrices according to the target transformation matrix in the frequency band b.

In an embodiment of the present disclosure, the decoding module 1203 is further configured to: obtain, from encoded information of a first channel group, first encoded information of the first channel group in any frequency band b; decode, based on a target decoding matrix for the first channel group in the frequency band b, first encoded information of the first channel group in the frequency band b, to obtain a first decoded frequency domain coefficient of the first channel group in the frequency band b; and obtain a second decoded frequency domain coefficient of the first channel group according to the first decoded frequency domain coefficient of the first channel group in each frequency band, where the second decoded frequency domain coefficient of the first channel group includes three outputs.

In an embodiment of the present disclosure, the first encoded information of the first channel group in any frequency band b includes at least center information, side information and first information in the frequency band b.

In an embodiment of the present disclosure, the decoding module 1203 is further configured to: determine a plurality of consecutive decoded channel groups that are adjacent to a current channel group as upmix channel groups corresponding to the current channel group; obtain first encoded information of the current channel group in any frequency band b from the encoded information; obtain a decoded frequency domain coefficient of the upmix channel group in each frequency band; decode the first encoded information in the frequency band b according to the target decoding matrix corresponding to the frequency band b and the decoded frequency domain coefficient in the frequency band b to obtain the first decoded frequency domain coefficient in the frequency band b; and obtain the decoded frequency domain coefficient of the current channel group according to the first decoded frequency domain coefficient of the current channel group in each frequency band, where the decoded frequency domain coefficient of the current channel group includes one output.

In an embodiment of the present disclosure, the first encoded information of the current channel group in any frequency band b includes first information of the current channel group in the frequency band b.

In the embodiments of the present disclosure, during the decoding process, the decoder uses frequency division decoding similar to that on the encoder side to restore the multi-channel audio signal. Since the encoder performs the compression, the multi-channel signal is easier to transmit, and it is possible to save a transmission space.

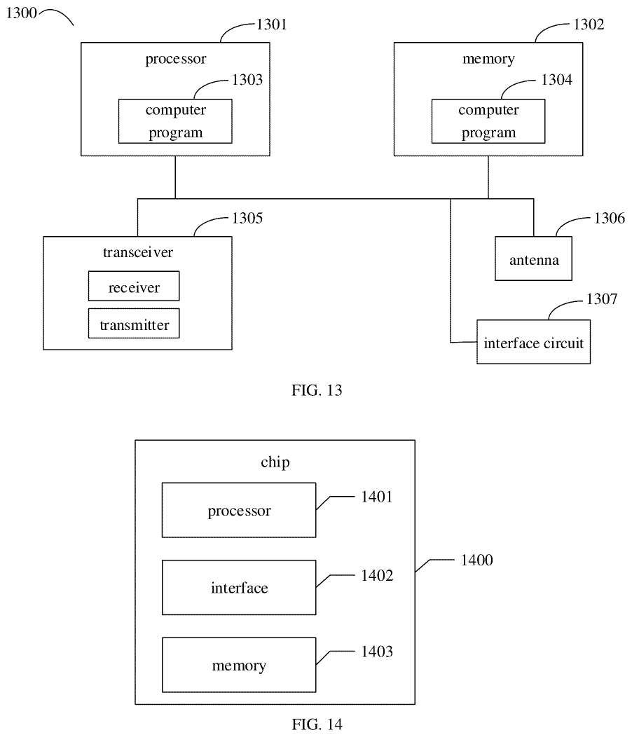

FIG. 13 is a schematic block diagram of another audio processing apparatus 1300 provided in an embodiment of the present disclosure. The audio processing apparatus 1300 may be an encoder or a decoder, or may be a chip, a chip system, a processor or the like supporting an encoder or a decoder to implement the above-mentioned methods. The audio processing apparatus 1300 may be configured to implement the methods as described in the above-mentioned method embodiments. For details, reference may be made to the description in the above-mentioned method embodiments.

The audio processing apparatus 1300 may include one or more processors 1301. The processor 1301 may be a general-purpose processor, a special-purpose processor, or the like. The processor 1301 may be, for example, a baseband processor or a central processor. The baseband processor may be configured to process a communication protocol and communication data, and the central processor may be configured to control an audio processing apparatus (such as a base station, a baseband chip, a decoder, a decoder chip, a DU, a CU, or the like), execute a computer program, and process data of the computer program.

In some embodiments, the audio processing apparatus 1300 may further include one or more memories 1302 on which a computer program 1304 may be stored, and the processor 1301 is configured to execute the computer program 1304 to cause the audio processing apparatus 1300 to perform the methods as described in the above-mentioned method embodiments. In some embodiments, the memory 1302 may also have data stored therein. The audio processing apparatus 1300 and the memory 1302 may be provided independently or integrated together.

In some embodiments, the audio processing apparatus 1300 may further include a transceiver 1305 and an antenna 1306. The transceiver 1305 may be referred to as a transceiving unit, a transceiving device, a transceiving circuit or the like for implementing a transceiving function. The transceiver 1305 may include a receiver and a transmitter, the receiver may be referred to as a receiving device, a receiving circuit or the like for implementing a receiving function; and the transmitter may be referred to as a transmitting device, a transmitting circuit or the like for implementing a transmitting function.

In some embodiments, the audio processing apparatus 1300 may further include one or more interface circuits 1307. The interface circuit 1307 is configured to receive and transmit code instructions to the processor 1301. The processor 1301 is configured to run the code instructions to enable the audio processing apparatus 1300 to perform the methods described in the above-mentioned method embodiments.

In an implementation, the processor 1301 may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface or the interface circuit may be configured to read and write code/data, or may be configured to transmit or transfer signals.

In an implementation, the processor 1301 may have stored therein the computer program 1303 that, when running on the processor 1301, enables the audio processing apparatus 1300 to perform the methods described in the above-mentioned method embodiments. The computer program 1303 may be embedded in the processor 1301, in which case the processor 1301 may be implemented by hardware.

In an implementation, the audio processing apparatus 1300 may include a circuit that may perform the transmitting, receiving or communicating function in the foregoing method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, or the like. The processor and the transceiver may also be fabricated with various IC process technologies, such as complementary metal oxide semiconductors (CMOSs), n-metal-oxide-semiconductors (NMOSs), positive channel metal oxide semiconductors (PMOSs), bipolar junction transistors (BJTs), bipolar CMOSs (BiCMOSs), silicon germanium (SiGe), gallium arsenide (GaAs), or the like.

The audio processing apparatus described in the above embodiments may be an encoder or a decoder, but the scope of the audio processing apparatus described in the present disclosure is not limited thereto. The structure of the audio processing apparatus may not be limited by FIG. 13. The audio processing apparatus may be a stand-alone device or may be part of a larger device. For example, the audio processing apparatus may be: (1) a stand-alone IC, or a chip, or a chip system or subsystem; (2) a set of one or more ICs, in which in some embodiments, the set of ICs may further include a storage component for storing data and computer programs; (3) an ASIC, such as a modem; (4) a module that may be embedded in other devices; (5) a receiver, a decoder, an intelligent decoder, a cellular phone, a wireless device, a handheld device, a mobile unit, an in-vehicle device, an encoder, a cloud device, an artificial intelligence device, or the like; or (6) others.

For the case where the audio processing apparatus may be a chip or a chip system, reference may be made to the schematic block diagram of the chip shown in FIG. 14. The chip 1400 shown in FIG. 14 includes a processor 1401 and an interface 1402. The number of the processors 1401 may be one or more, and the number of the interfaces 1402 may be multiple.

Optionally, the chip further includes a memory 1403 for storing desired computer programs and data.

In some implementations, the chip may be configured to implement the functions of the decoder in the above embodiments of the present disclosure.

In some implementations, the chip may be configured to implement the functions of the encoder in the above embodiments of the present disclosure.

Those skilled in the art may also understand that various illustrative logical blocks and steps listed in the embodiments of the present disclosure may be implemented by electronic hardware, computer software, or a combination thereof. Whether such functions are implemented by hardware or software depends on specific applications and design requirements of an overall system. For each specific application, those skilled in the art may use various methods to implement the functions, but such implementations should not be understood as extending beyond the protection scope of embodiments of the present disclosure.

An embodiment of the present disclosure further provides an audio processing system, which includes the audio processing apparatus in the above embodiments of FIG. 13 as an encoder and the audio processing apparatus in the above embodiments of FIG. 13 as a decoder, or includes the audio processing apparatus in the above embodiments of FIG. 14 as an encoder and the audio processing apparatus in the above embodiments of FIG. 14 as a decoder.

An embodiment of the present disclosure further provides a non-transitory computer-readable storage medium having stored therein instructions that, when executed by a computer, cause functions of any one of the above-mentioned method embodiments to be implemented.

An embodiment of the present disclosure further provides a computer program product including a computer program that, when executed by a computer, causes functions in any one of the above-mentioned method embodiments to be implemented.

An embodiment of the present disclosure further provides a computer program that, when run on a computer, causes the computer to perform functions in any one of the above-mentioned method embodiments.

It should be noted that the above explanations of the method and apparatus embodiments are also applicable to the electronic device, the non-transitory computer-readable storage medium, the computer program product and the computer program in the above embodiments, and will not be repeated here.

All or some of the above embodiments may be implemented by software, hardware, firmware or any combination thereof. When implemented using the software, all or some of the above embodiments may be implemented in a form of the computer program product. The computer program product includes one or more computer programs. When the computer program is loaded and executed on the computer, all or some of the processes or functions according to embodiments of the present disclosure will be generated. The computer may be a general-purpose computer, a special-purpose computer, a computer network, or other programmable devices. The computer program may be stored in a non-transitory computer-readable storage medium, or transmitted from one non-transitory computer-readable storage medium to another non-transitory computer-readable storage medium. For example, the computer program may be transmitted from one website, computer, server or data center to another website, computer, server or data center in a wired manner (such as via a coaxial cable, an optical fiber, a digital subscriber line DSL) or a wireless manner (for example, in an infrared, wireless, or microwave manner, or the like). The non-transitory computer-readable storage medium may be any available medium that may be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc DVD), a semiconductor medium (for example, a solid state disk SSD), or the like.

Those of ordinary skill in the art may understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In the embodiments of the present disclosure, for a certain kind of technical features, the technical features in this kind of technical features are distinguished by terms like “first”, “second”, “third”, “A”, “B”, “C”, “D”, and the like, and these technical features described with the terms “first”, “second”, “third”, “A”, “B”, “C” and “D” have no order of precedence or magnitude.

The corresponding relationships shown in the tables in the present disclosure may be configured or predefined. The values of information in each table are only given by way of example and may be configured as other values, which are not limited in the present disclosure. When configuring the corresponding relationship between the information and each parameter, it is not necessarily required to configure all the corresponding relationships illustrated in each table. For example, in the table in the present disclosure, the corresponding relationships shown in some rows may not be configured. For another example, appropriate adjustments may be made based on the above table, such as splitting, merging, or the like. The names of the parameters shown in the titles of the above tables may also use other names that may be understood by the audio processing apparatus, and the values or representations of the parameters may also be other values or representations that may be understood by the audio processing apparatus. When implementing the above tables, other data structures may also be used, such as arrays, queues, containers, stacks, linear lists, pointers, linked lists, trees, graphs, structures, classes, heaps, hash tables or hashed lists.

The term “predefined” in the present disclosure may be understood as defined, pre-defined, stored, pre-stored, pre-negotiated, pre-configured, solidified, or pre-burned.

Those of ordinary skill in the art will appreciate that the units and algorithm steps of each example described in conjunction with the embodiments of the present disclosure may be implemented in electronic hardware, or a combination of computer software and electronic hardware. Whether these functions are performed in hardware or software depends on the specific application and design constraints of the technical solution. Professional technicians may use different methods to implement the described functions for each specific application, but such an implementation should not be understood as extending beyond the scope of the present disclosure.

Those skilled in the art may clearly understand that, for the convenience and brevity of description, regarding the specific working processes of the systems, devices and units described above, reference may be made to the corresponding processes in the aforementioned method embodiments, which will not be repeated here.

The above are only specific embodiments of the present disclosure, but the protection scope of the present disclosure is not limited thereto. Any person skilled in the art who is familiar with this technical field may easily think of changes or substitutions within the technical scope defined in the present disclosure, which should be included in the protection scope of the present disclosure. Therefore, the protection scope of the present disclosure should be based on the protection scope of the claims.

All embodiments of the present disclosure may be implemented individually or in combination with other embodiments, and are all considered to be within the protection scope as claimed in the present disclosure.

1. An audio encoding method, performed by an encoder and comprising:
obtaining a plurality of channel groups by performing a grouping on a channel sequence, wherein each of the plurality of channel groups comprises a plurality of consecutive channels in the channel sequence, and adjacent channel groups comprise one or more identical channels;
obtaining a frequency domain coefficient of each frame in each channel by performing a frequency domain conversion on an audio signal in each channel in the channel sequence frame by frame;
determining a target transformation matrix corresponding to the channel group in each frequency band in a frequency band set from a transformation matrix set according to the frequency domain coefficient of each channel;
obtaining encoded information of the channel group by performing an identical-band decorrelation processing on the frequency domain coefficient of the channel in the channel group based on the target transformation matrix in each frequency band; and
obtaining an encoded stream based on the encoded information of the channel group, and sending the encoded stream to a decoder for decoding.

2. The method according to claim 1, wherein determining the target transformation matrix in each frequency band corresponding to the channel group from the transformation matrix set according to the frequency domain coefficient of each channel comprises:
determining a first cross-correlation matrix between channels corresponding to each frequency band according to the frequency domain coefficient of each channel;
determining a second cross-correlation matrix for the channel group from the first cross-correlation matrix in each frequency band, wherein the second cross-correlation matrix comprises cross-correlation coefficients between channels in the channel group; and
determining the target transformation matrix for the channel group in each frequency band from the transformation matrix set based on the second cross-correlation matrix for the channel group in each frequency band.

3. The method according to claim 1, wherein obtaining the encoded information of the channel group by performing the identical-band decorrelation processing on the frequency domain coefficient of the channel in the channel group based on the target transformation matrix in each frequency band comprises:
obtaining frequency domain coefficients of the channels in the channel group in any frequency band b, and obtaining first encoded information of the channel group in the frequency band b based on the frequency domain coefficients in the frequency band b and the target transformation matrix corresponding to the frequency band b;
obtaining second encoded information of the channel group according to the first encoded information of the channel group in each frequency band; and
obtaining the encoded information of the channel group based on the second encoded information and the target transformation matrix corresponding to each frequency band.

4. The method according to claim 2, wherein determining the target transformation matrix for the channel group in each frequency band from the transformation matrix set based on the second cross-correlation matrix for the channel group in each frequency band comprises:
determining, based on the second cross-correlation matrix in any frequency band b, the cross-correlation coefficient between any two channels in the channel group in the frequency band b; and
determining, according to the cross-correlation coefficient between any two channels in the channel group in the frequency band b, the target transformation matrix for the channel group in the frequency band b from the transformation matrix set.

5. The method according to claim 4, wherein determining, according to the cross-correlation coefficient between any two channels in the channel group in the frequency band b, the target transformation matrix for the channel group in the frequency band b from the transformation matrix set comprises:
in a case where the cross-correlation coefficient between the two channels meets a condition for selecting a specified transformation matrix in the transformation matrix set, selecting the specified transformation matrix as the target transformation matrix in the frequency band b; and
in a case where the cross-correlation coefficient between the two channels does not meet the condition, according to a maximum cross-correlation coefficient between the two channels, selecting a transformation matrix other than the specified transformation matrix from the transformation matrix set as the target transformation matrix in the frequency band b.

6. The method according to claim 2, wherein determining the first cross-correlation matrix between channels the corresponding to each frequency band according to the frequency domain coefficient of each channel comprises:
determining an energy value of any channel in each frequency band according to the frequency domain coefficient of the channel; and
determining the first cross-correlation matrix corresponding to each frequency band according to the energy value of each channel in each frequency band.

7. The method according to claim 6, wherein determining the first cross-correlation matrix corresponding to each frequency band according to the energy value of each channel in each frequency band comprises:
obtaining an energy ratio of any two channels in the channel sequence in any frequency band b;
in a case where the energy ratio in the frequency band b is less than or equal to a first set threshold, or the energy ratio in the frequency band b is greater than or equal to a second set threshold, determining that the cross-correlation coefficient between the two channels in the frequency band b is zero, wherein the first set threshold is less than the second set threshold;
in a case where the energy ratio in the frequency band b is between the first set threshold and the second set threshold, determining the cross-correlation coefficient of the two channels in the frequency band b according to the frequency domain coefficients of the two channels in the frequency band b; and
obtaining the first cross-correlation matrix corresponding to the frequency band b based on the cross-correlation coefficient of the two channels in the frequency band b.

8. The method according to claim 2, wherein determining the second cross-correlation matrix for the channel group from the first cross-correlation matrix in each frequency band further comprises:
normalizing the first cross-correlation matrix in each frequency band, and extracting the second cross-correlation matrix corresponding to the channel group in each frequency band from a normalized first cross-correlation matrix in each frequency band according to the channels comprised in the channel group.

9. The method according to claim 7, wherein normalizing the first cross-correlation matrix comprises:
determining a channel identifier associated with an arbitrary matrix element in the first cross-correlation matrix;
determining a normalized matrix element corresponding to the arbitrary matrix element according to the channel identifier associated; and
obtaining a normalization result of the arbitrary matrix element according to the arbitrary matrix element and the normalized matrix element.

10. The method according to claim 3, further comprising:
for a first channel group, obtaining first encoded information of the first channel group in the frequency band b based on frequency domain coefficients of channels in the first channel group in the frequency band b, and according to the frequency domain coefficients in the frequency band b and the target transformation matrix corresponding to the frequency band b, wherein the first encoded information comprises center information, side information, and first information of the first channel group; and
for each remaining channel group except the first channel group, obtaining first encoded information of the remaining channel group in the frequency band b based on frequency domain coefficients of channels in the remaining channel group in the frequency band b, and according to the frequency domain coefficients in the frequency band b and the target transformation matrix corresponding to the frequency band b, wherein the first encoded information comprises first information of the remaining channel group.

11. The method according to claim 1, wherein one or more overlapping channels exist between the adjacent channel groups, and the method comprises:
determining that the adjacent channel groups comprise a first channel group and a second channel group, wherein the first channel group and the second channel group each comprise three consecutive channels in the channel sequence, and the first channel group and the second channel group comprise two identical channels.

12. An audio decoding method, performed by a decoder and comprising:
receiving an encoded stream sent by an encoder, wherein the encoded stream comprises encoded information of a plurality of channel groups, the plurality of channel groups are obtained by performing a grouping on a channel sequence sequentially, each of the plurality of the channel groups comprises a plurality of consecutive channels in the channel sequence, and adjacent channel groups comprise one or more identical channels;
decoding the plurality of channel groups sequentially, and determining, for a current channel group decoded, a target decoding matrix corresponding to the current channel group in each frequency band in a frequency band set according to encoded information of the current channel group;
obtaining a decoded frequency domain coefficient of the current channel group for the encoded information of the current channel group based on the target decoding matrix for the current channel group in each frequency band; and
obtaining a decoded audio signal in each channel in the channel sequence according to the decoded frequency domain coefficients of the plurality of channel groups.

13. The method according to claim 12, wherein determining the target decoding matrix corresponding to the current channel group in each frequency band in the frequency band set according to the encoded information of the current channel group comprises:
obtaining a target transformation matrix in each frequency band from the encoded information; and
obtaining the target decoding matrix for the current channel group in any frequency band b by querying a mapping relationship between transformation matrices and decoding matrices according to the target transformation matrix in the frequency band b.

14. The method according to claim 12, wherein in a case where the current channel group is a first channel group among the plurality of channel groups, obtaining the decoded frequency domain coefficient of the current channel group for the encoded information of the current channel group based on the target decoding matrix for the current channel group in each frequency band comprises:
obtaining, from encoded information of the first channel group, first encoded information of the first channel group in any frequency band b;
decoding, based on a target decoding matrix for the first channel group in the frequency band b, first encoded information of the first channel group in the frequency band b, to obtain a first decoded frequency domain coefficient of the first channel group in the frequency band b; and
obtaining a second decoded frequency domain coefficient of the first channel group according to the first decoded frequency domain coefficient of the first channel group in each frequency band, wherein the second decoded frequency domain coefficient of the first channel group comprises three outputs.

15. The method according to claim 14, wherein the first encoded information of the first channel group in any frequency band b comprises at least center information, side information and first information in the frequency band b.

16. The method according to claim 12, wherein in a case where the current channel group is a channel group other than a first channel group among the plurality of channel groups, obtaining the decoded frequency domain coefficient of the current channel group for the encoded information of the current channel group based on the target decoding matrix for the current channel group in each frequency band comprises:
determining a plurality of consecutive decoded channel groups that are adjacent to the current channel group as upmix channel groups corresponding to the current channel group;
obtaining first encoded information of the current channel group in any frequency band b from the encoded information;
obtaining a decoded frequency domain coefficient of the upmix channel group in each frequency band;
decoding the first encoded information in the frequency band b according to the target decoding matrix corresponding to the frequency band b and the decoded frequency domain coefficient in the frequency band b to obtain a first decoded frequency domain coefficient in the frequency band b; and
obtaining the decoded frequency domain coefficient of the current channel group according to the first decoded frequency domain coefficient of the current channel group in each frequency band, wherein the decoded frequency domain coefficient of the current channel group comprises one output.

17.-19. (canceled)

20. An encoder, comprising:
a processor; and
a memory for storing instructions executable by the processor,
wherein the processor is configured to;
obtain a plurality of channel groups by performing a grouping on a channel sequence, wherein each of the plurality of channel groups comprises a plurality of consecutive channels in the channel sequence, and adjacent channel groups comprise one or more identical channels;
obtain a frequency domain coefficient of each frame in each channel by performing a frequency domain conversion on an audio signal in each channel in the channel sequence frame by frame;
determine a target transformation matrix corresponding to the channel group in each frequency band in a frequency band set from a transformation matrix set according to the frequency domain coefficient of each channel;
obtain encoded information of the channel group by performing an identical-band decorrelation processing on the frequency domain coefficient of the channel in the channel group based on the target transformation matrix in each frequency band; and
obtain an encoded stream based on the encoded information of the channel group, and send the encoded stream to a decoder for decoding.

21. A decoder, comprising:
a processor; and
a memory for storing instructions executable by the processor,
wherein the processor is configured to perform the method according to claim 12.

22. A non-transitory computer-readable storage medium having stored therein computer program instructions that, when executed by a processor, cause the processor to perform the method according to claim 1.

23. A non-transitory computer-readable storage medium having stored therein computer program instructions that, when executed by a processor, cause the processor to perform the method according to claim 12.

24.-27. (canceled)
